(19) United States
(12) Patent Application Publication
(10) Pub. No.: US 2026/0270109 A1
(43) Pub. Date: Sep. 10, 2026

(54) METHODS AND APPARATUS TO PERFORM DATA ENCAPSULATION OVER SERIAL LINKS

(71) Applicant: Texas Instruments Incorporated, Dallas, TX (US)

(72) Inventor: Ravi Aripirala, Bengaluru (IN)

(21) Appl. No.: 19/072,773

(22) Filed: Mar. 6, 2025

(51) Int. Cl. H04L 12/40; H04L 69/324

(52) U.S. Cl. CPC H04L 12/4013; H04L 69/324; H04L 2012/40273

(57) ABSTRACT

Methods, apparatus, systems, and articles of manufacture to perform data encapsulation over serial links are described. An example apparatus comprises a media access control layer configurable to provide first data in a first format and receive second data in the first format; a first buffer configurable to store the first data from the media access control layer; encapsulation controller configurable to convert the first data in the first format to a second format; a transmitter having an input and an output, the input of the transmitter coupled to an output of the encapsulation controller; a second buffer configurable to provide stored data in the first format to the media access control layer, the stored data including the second data; and a controller configurable to, after an amount of data in the first buffer is above a threshold, store a pause frame in the second buffer.

### TECHNICAL FIELD

This description relates generally to electrical systems, and, more particularly, to methods and apparatus to perform data encapsulation over serial links.

### BACKGROUND

Some electrical systems include first endpoints, such as sensors, that capture information and provide the information to a second endpoint, such as a central processing device, to perform one or more actions or operations based on the captured sensor information. Such systems may include different components communicating using different protocols. For example, a system may include one or more links to communicate data using Ethernet protocols, flat panel display (FPD) protocols, differential protocols, etc. The structure or timing of the transmission of data packets that are transmitted to/from endpoint to endpoint or the hardware to transport the data packets may be different for the different protocols.

### SUMMARY

For performing data encapsulation over serial links, an example apparatus includes a media access control layer configured to provide first data in a first format and receive second data in the first format. The apparatus also includes a first buffer configured to store the first data from the media access control layer. The apparatus also includes an encapsulation controller configured to convert the first data in the first format to a second format. The apparatus also includes a transmitter having an input and an output, the input of the transmitter coupled to an output of the encapsulation controller. The apparatus also includes a second buffer configured to provide stored data in the first format to the media access control layer, the stored data including the second data. The apparatus also includes a controller configured to, after an amount of data in the first buffer is above a threshold, store a pause frame in the second buffer. Other examples are described.

For performing data encapsulation over serial links, an example method includes a first buffer configured to store first data in a first format. The apparatus also includes an encapsulation controller configured to convert the first data in the first format to a second format. The apparatus also includes a transmitter having an input and an output, the input of the transmitter coupled to an output of the encapsulation controller, the output of the transmitter coupled to a first endpoint. The apparatus also includes a second buffer configured to provide stored second data in the first format to a second endpoint. The apparatus also includes a controller configured to cause the first endpoint to stop sending additional data to the second buffer based on an amount of data in the second buffer being above a threshold. Other examples are described.

For performing data encapsulation over serial links, an example system includes sensor circuitry including an input and an output, the sensor circuitry configured to: monitor an amount of data stored in a second buffer, the second buffer storing received data from a processor endpoint; and after the amount of data stored in the second buffer is above a threshold, store a pause frame into a first buffer, the first buffer storing data to be transmitted to the processor endpoint; and the processor endpoint an input and an output, the input of the processor endpoint coupled to the output of the sensor circuitry and the output of the processor endpoint coupled to the first input of the sensor circuitry, the processor endpoint configured to: transmit the data to the sensor circuitry; and after receiving the pause frame from the sensor circuitry, pause transmission of the data to the sensor circuitry for a threshold amount of time. Other examples are described.

### BRIEF DESCRIPTION OF THE DRAWINGS

FIG. 1 is a block diagram of an example vehicle including an example advanced driver-assistance (ADAS) system and an example in-vehicle infotainment (IVI) system.

FIG. 2 is a block diagram of an example of the ADAS system of FIG. 1 including example deserializer circuitry and example serializer circuitry.

FIG. 3 is a block diagram of an example IVI system of FIG. 1 including example serializer circuitry, and example deserializer circuitry.

FIG. 4 is a block diagram including examples of the serializer and deserializer circuitry of FIGS. 2 and 3, which may be referred to as a serial-deserializer (SerDes) system, the serializer and deserializer circuitry further including retimer circuitry.

FIG. 5 illustrates an example system for transmitting data between two endpoints.

FIG. 6 illustrates an example block diagram of the sensor circuitry, aggregator, and processor of FIG. 5.

FIG. 7 includes an example block diagram of the serial link circuitry of FIGS. 2-4 and 6.

FIG. 8A illustrates an example Ethernet-based data packet.

FIG. 8B illustrates an example serial-based data packet.

FIGS. 9-10 illustrate a flowchart representative of hardware operation, example machine readable instructions or example operations that may be executed, instantiated, or performed by example programmable circuitry to the serial link circuitry of FIG. 7.

FIG. 11 is a block diagram of an example processing platform including programmable circuitry structured to execute, instantiate, or perform the example machine readable instructions or perform the example operations of FIGS. 9-10 to implement the serial link circuitry of FIG. 7.

FIG. 12 is a block diagram of an example software/firmware/instructions distribution platform (such as one or more servers) to distribute software, instructions, or firmware (corresponding to the example machine readable instructions of FIGS. 9-10) to client devices associated with end users or consumers, such as for license, sale, or use, retailers, such as for sale, re-sale, license, or sub-license, or original equipment manufacturers (OEMs) (for inclusion in products to be distributed to, for example, retailers or to other end users such as direct buy customers).

The same reference numbers or other reference designators are used in the drawings to designate the same or similar (functionally or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, the boundaries or lines may be unobservable, blended or irregular.

In some systems, several sensors can be combined into a sensor network for processing at a centralized unit. For example, in the automotive field, driver assistant functions or autonomous driving decisions may be based on information from a number of sensors in an automobile. The sensors, such as cameras, sensors, etc., may provide visual data or location data about an environment around the automobile while static (e.g., not moving) or in motion.

In some automotive systems, visual spectrum sensors, such as video cameras, utilize SerDes protocols, such as mobile industry processor interface (MIPI) protocols, flat panel display (FPD) link protocols, etc. Also, in such automotive systems, radio frequency (RF) backscatter or radar sensors utilize automotive Ethernet protocols. Accordingly, such automotive systems require two different structures and protocols to operate (e.g., FPD and Ethernet).

Examples described herein integrate sensor data from both diverse networks, such as video and radar networks, into a single serial bidirectional link, such as a Coax cable, thereby benefiting from integration cost reductions in the vehicle. Accordingly, using examples described herein, links between endpoints can be based on SerDes protocols to create uniform links within a system. To integrate the two protocols into one system, examples described herein encapsulate Ethernet traffic into serial link datagrams and transport the serial link datagrams across the SerDes links to an endpoint. After receiving a datagram, the endpoint decapsulates the datagram back into Ethernet data that the endpoint can process. In this manner, Ethernet-based sensors can generate Ethernet-based data using Ethernet protocols, the Ethernet data can be encapsulated to transform the Ethernet data into SerDes data that can be used in SerDes links, and after being received by an endpoint, the SerDes data can be converted back to Ethernet data so that the endpoint can process using Ethernet-based protocols. Examples described herein thereby eliminate the need for two different links, such as SerDes and Ethernet, and unifies the links within the system.

Only encapsulating an Ethernet packet to a SerDes packet may result in output packet loss due to the difference in bandwidth of Ethernet protocols vs SerDes protocols. For example, if the Ethernet-based sensor is generating data faster than the SerDes protocol can transmit the data, some of the output Ethernet data is dropped. To complicate the issue, the baud rates of the two directions of a SerDes link may be different. To overcome such problems, examples described herein use the pause frame of the Ethernet protocol to force the Ethernet protocol to pause the output of additional data as the output buffer for the serial link reaches capacity. Examples described herein monitor an amount of free storage in the output buffer and, if the amount of free storage is below a threshold, the examples inject a pause frame into an input buffer. In this manner, the pause frame is transmitted back to the MAC layer of the Ethernet-based sensor and pause output of additional data for a duration of time based on receiving the pause output. In this manner, examples described herein can eliminate packet loss regardless of differences in baud rates of the Ethernet protocol and the serial protocol.

In some examples, generating and storing the pause frame in the input buffer may cause the input buffer of the sensor to reach capacity, which may result in input packet loss. Accordingly, examples described herein monitor the number of packets stored in the input buffer. If the number of data packets (also referred to as data frames or datagrams) in the input buffer is above a threshold, examples described herein store a pause frame into the output buffer, thereby causing the pause frame to be transmitted to the connected endpoint device, such as the processing device. In this manner, the processing endpoint device pauses the output of additional data to the sensor device so that the input buffer of the sensor device does not fill and cause packet drop. Accordingly, examples described herein provide application agnostic communication links that can utilize different protocols in a system that eliminates packet loss at the input and output of a sensor.

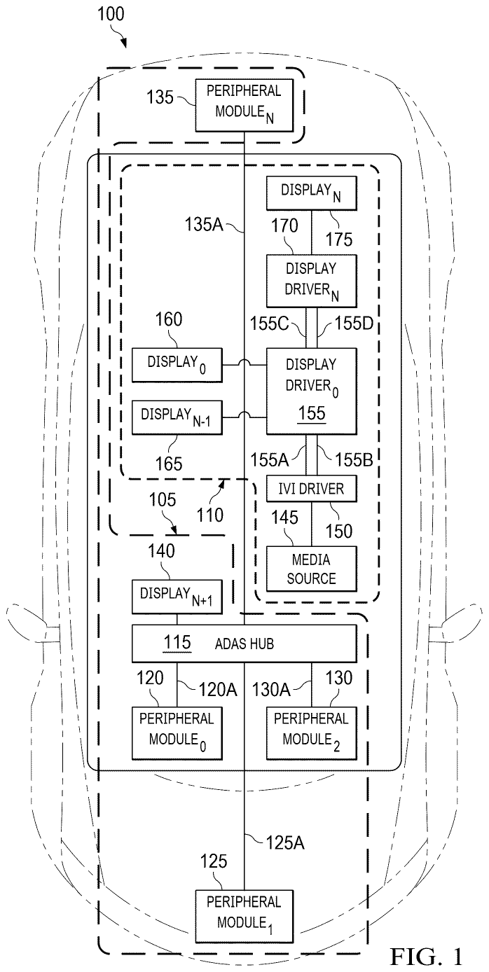

FIG. 1 is a block diagram of an example vehicle 100 including an example advanced driver-assistance (ADAS) system 105 and an example in-vehicle infotainment (IVI) system 110. The ADAS system 105 and the IVI system 110 may be referred to as flat panel display (FPD) link systems that may display media, such as images, multi-media content, etc. In some examples, the vehicle 100 may include one or more instances of the ADAS system 105 or the IVI system 110. For example, the vehicle 100 may include one or more instances of the ADAS system 105 without the IVI system 110. In another example, the vehicle 100 may include one or more instances of the IVI system 110 without the ADAS system 105. In yet another example, the vehicle 100 may include one or more instances of the ADAS system 105 and one or more instances of the IVI system 110. In the example of FIG. 1, the vehicle 100 is illustrated as a system for traversing distances, such as a car, a truck, etc. Alternatively, the vehicle 100 may be replaced, illustrated, or described as an alternative distributed display system, such as a boat, airplane, spacecraft, workstation, control panel, etc.

The ADAS system 105 of FIG. 1 includes an example ADAS hub 115, a first example peripheral module 120, a second example peripheral module 125, a third example peripheral module 130, a fourth example peripheral module 135, and an example display 140. Alternatively, the ADAS system 105 may include any number of peripheral module(s) or display(s).

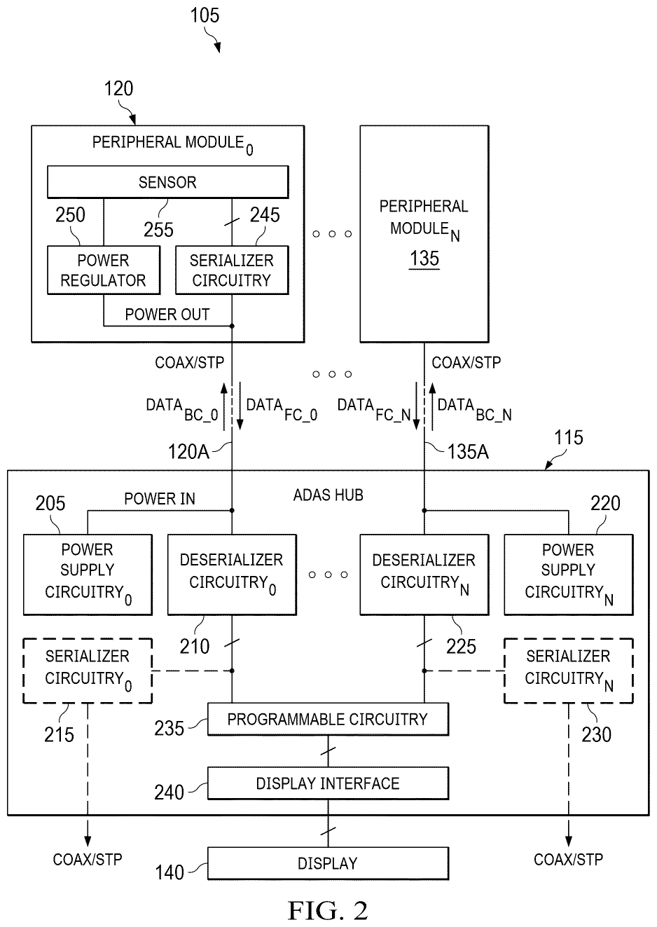

The ADAS system 105 is an example type of FPD-link system that utilizes serializing and deserializing data for driving assistance in the vehicle 100. In some examples, the ADAS system 105 utilizes serializing and deserializing media for an alternative implementation of processing, storing, or displaying data, such as a security system, recording system, etc. In some examples, the ADAS system 105 is an example camera system that facilitates at least one of the storing, processing, or displaying multi-media data (e.g., images, videos, etc.) from one or more sensors, such as cameras. In other examples, the ADAS system 105 may facilitate at least one of the storing, processing, or displaying an alternative type of data from one or more alternative types of sensors (e.g., lidar, radar, ultrasonic, etc.). An example of the ADAS system 105 is further illustrated and described in connection with FIG. 2.

The ADAS hub 115 is communicatively coupled to the peripheral modules 120, 125, 130, 135 and the display 140. The ADAS hub 115 uses full duplex communications to transmit data to and receive data from the peripheral modules 120, 125, 130, 135. In some examples, the ADAS hub 115 uses low-voltage differential signaling (LVDS) to communicate with the peripheral modules 120, 125, 130, 135. Alternatively, the ADAS hub 115 may use an alternative type of signaling to communicate with the peripheral modules 120, 125, 130, 135, such as display serial interface (DSI), embedded display port (eDP), etc. The ADAS hub 115 may at least one of store, process, or display data from the peripheral modules 120, 125, 130, 135. In the example of FIG. 1, the ADAS hub 115 displays the data from one or more of the peripheral modules 120, 125, 130, 135 using the display 140. The ADAS hub 115 uses multi-lane signaling to display data using the display 140. Also, the ADAS hub 115 may also at least one of store or process data from the peripheral modules 120, 125, 130, 135 for other functions of the vehicle 100, such as object recognition, time of flight calculations, etc. An example of the ADAS hub 115 is further illustrated and described in connection with FIG. 2.

The peripheral modules 120, 125, 130, 135 are communicatively coupled to the ADAS hub 115. The peripheral modules 120, 125, 130, 135 include at least one sensor that receives information of the surrounding environment, such as images, videos, time of flight measurements, beamforming data, etc. The peripheral modules 120, 125, 130, 135 transmit the received sensor data to the ADAS hub 115 using communication channels 120A, 125A, 130A, 135A. In some examples, the communication channels 120A, 125A, 130A, 135A are coaxial connectors, which couple the ADAS hub 115 to the peripheral modules 120, 125, 130, 135. In such examples, the ADAS hub 115 supplies power to the peripheral modules 120, 125, 130, 135 using power over coax (POC) across the communication channels 120A, 125A, 130A, 135A. Alternatively, the communication channels 120A, 125A, 130A, 135A may be formed by a different type of connector, such as a standard twisted pair (STP). An example of the peripheral modules 120, 125, 130, 135 are further illustrated and described in connection with FIG. 2.

In example operation of the ADAS system 105 of FIG. 1, the peripheral modules 120, 125, 130, 135 produce video streams of the environment surrounding the vehicle 100. The peripheral modules 120, 125, 130, 135 serialize data of the video streams. The peripheral modules 120, 125, 130, 135 transmit the serial data streams to ADAS hub 115 using the communication channels 120A, 125A, 130A, 135A. Concurrently, the ADAS hub 115 may transmit data to the peripheral modules 120, 125, 130, 135 using the communication channels 120A, 125A, 130A, 135A. Communications between the ADAS hub 115 and the peripheral modules 120, 125, 130, 135 may occur simultaneously. Such multi-directional communications across the same one of the communication channels 120A, 125A, 130A, 135A are referred to as full duplex communications.

In such example operations of the ADAS system 105 of FIG. 1, the ADAS hub 115 receives the serial data streams from the peripheral modules 120, 125, 130, 135. The ADAS hub 115 deserializes the data streams to reconstruct the video streams captured by the peripheral modules 120, 125, 130, 135. The ADAS hub 115 at least one of stores, processes, or displays the video streams for driver assistance. For example, the ADAS hub 115 displays the video stream of the peripheral module 135 on the display 140 based on a determination that the perspective corresponding to the peripheral module 135 is needed. In another example, the ADAS hub 115 stores or process video streams of the peripheral modules 120, 125, 130, 135 for detecting safety hazards in the environment of the vehicle 100.

Example operations of the ADAS system 105 are further described in connection with FIG. 2. Serializing and deserializing data from the peripheral modules 120, 125, 130, 135 reduces the number of connections within the vehicle 100 to the ADAS hub 115. The serial data streams are capable of accurately traversing relatively large distances across the communication channels 120A, 125A, 130A, 135A.

The IVI system 110 of FIG. 1 includes an example media source 145, example IVI driver circuitry 150, a first example display driver 155, a first example display 160, a second example display 165, a second example display driver 170, and a third example display 175. Alternatively, the IVI system 110 may include any number of display driver(s) or display(s).

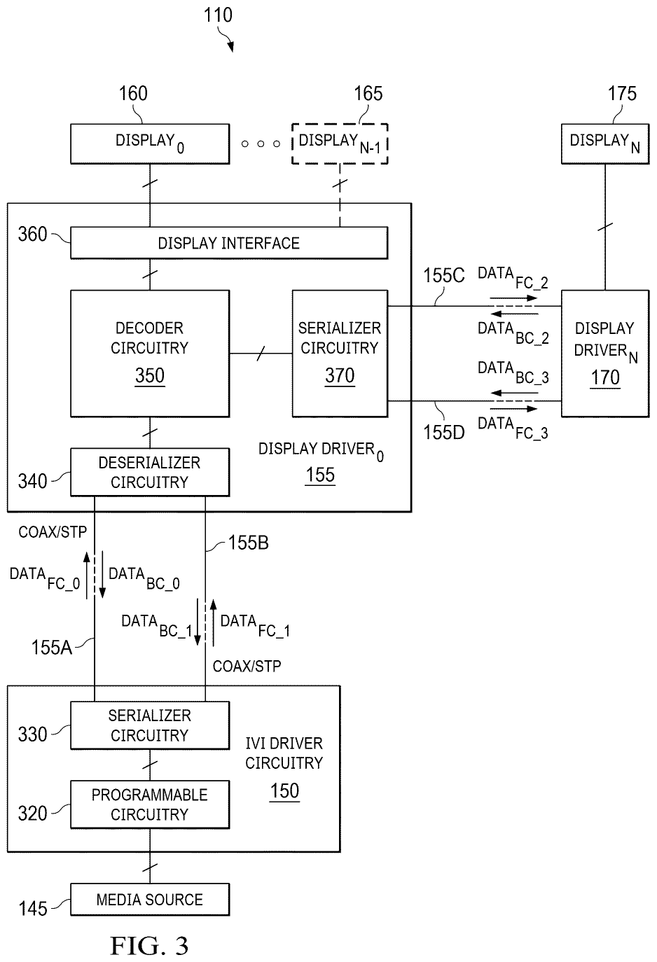

The IVI system 110 is an example type of FPD-link system that utilizes serializing and deserializing media for infotainment on one or more displays (e.g., the displays 160, 165, 175). In some examples, the IVI system 110 is a dashboard having multiple displays for displaying content. In other examples, the IVI system 110 is a different display system having multiple displays for displaying content, such as a studio, workstation, etc. In the example of FIG. 1, the IVI system 110 includes the media source 145, the IVI driver circuitry 150, the display drivers 155, 170, and the displays 160, 165, 175. Alternatively, the IVI system 110 may include any number of media source(s), display driver(s), or display(s). An example of the IVI system 110 is further illustrated and described in connection with FIG. 3.

In the IVI system 110, the media source 145 is coupled to the IVI driver circuitry 150. The media source 145 supplies media to the IVI driver circuitry 150 for display on one or more of the displays 160, 165, 175. In some examples, the media source 145 is integrated in the vehicle 100, such as circuitry supporting a data stream or memory storing media. In other examples, the media source 145 represents a connection to a device that is external to the vehicle 100, such as a wireless connection to a service hosting a multi-media stream.

The IVI driver circuitry 150 is communicatively coupled to the media source 145 and the display driver 155. The IVI driver circuitry 150 processes multi-media data from the media source 145 for transmission to one or more of the display drivers 155, 170. The IVI driver circuitry 150 uses full duplex communications to transmit data to and receive data from the display driver 155. In some examples, the IVI driver circuitry 150 uses LVDS to communicate with the display driver 155. In such examples, the IVI driver circuitry 150 indirectly communicates with the display driver 170 through the display driver 155. Such an example is further illustrated and described in connection with FIG. 3. Alternatively, the IVI driver circuitry 150 may use an alternative type of signaling to communicate with the display driver 155, such as DSI, eDP, etc. An example of the IVI driver circuitry 150 is further illustrated and described in connection with FIG. 3.

The display driver 155 is communicatively coupled to the IVI driver circuitry 150, the displays 160, 165, and the display driver 170. The display driver 155 interfaces with the IVI driver circuitry 150 using first and second communication channels 155A, 155B. The display driver 155 interfaces with the display driver 170 using third and fourth communication channels 155C, 155D. In the example of FIG. 1, first and second coaxial connectors form the communication channels 155A, 155B between the IVI driver circuitry 150 and the display driver 155. Similarly, third and fourth coaxial connectors form the communication channels 155C, 155D between the display drivers 155, 170. The display driver 155 uses multi-lane signaling to display media on the displays 160, 165. In some examples, the display driver 155 decodes additional data from the IVI driver circuitry 150 to determine which one of the displays 160, 165 corresponds to the data. Although the display driver 155 of FIG. 1 is coupled to the displays 160, 165, the display driver 155 may be coupled to any number of display(s). An example of the display driver 155 is further illustrated and described in connection with FIG. 3.

The display driver 170 is communicatively coupled to the display driver 155 and the display 175. In some examples, the display driver 170 may be coupled to another instance of the display driver 170 (similar to the communication channels 155A, 155B, 155C, 155D of the display driver 155). The display driver 170 interfaces with the display driver 155 using the communication channels 155C, 155D. The display driver 170 uses multi-lane signaling to display multi-media data using the display 175. Although the display driver 155 of FIG. 1 is coupled to the display 175, the display driver 170 may be coupled to any number of display(s).

In an example operation of the IVI system 110 of FIG. 1, the media source 145 supplies media for display on at least one of the displays 160, 165, 175. The IVI driver circuitry 150 determines one or more of the displays 160, 165, 175 to display the media from the media source 145. The IVI driver circuitry 150 determines which of the display drivers 155, 170 are coupled to the one or more of the displays 160, 165, 175. The IVI driver circuitry 150 generates an identifier(s) that specifies at least one of the one or more of the display drivers 155, 170 or one or more of the displays 160, 165, 175. The IVI driver circuitry 150 combines the identifying data and the media from the media source 145. The IVI driver circuitry 150 generates a serial data stream by serializing the combined data for transmission on at least one of the communication channels 155A, 155B.

In such example operations of the IVI system 110, the display driver 155 receives the serial data stream representing the media and identifying data. The display driver 155 deserializes the serial data stream(s) from the communication channels 155A, 155B. The display driver 155 decodes the identifying data to determine if the media corresponds to either of the displays 160, 165. If the display driver 155 determines that the media corresponds to one or more of the displays 160, 165, the display driver 155 displays the media on one or more of the displays 160, 165. If the display driver 155 determines that the media does not correspond to one or more of the displays 160, 165, the display driver 155 regenerates the serial data stream by reserializing the combined media and identifying data. The display driver 155 transmits the serial data to the display driver 170 via at least one of the communication channels 155C, 155D. After receiving the serial data stream from the communication channels 155C, 155D, the display driver 155 deserializes the serial data stream(s). The display driver 170 decodes the identifying data to determine if the media corresponds to the display 175. If the display driver 170 determines that the identifying data corresponds to the display 175, the display driver 170 displays the media on the display 175. In some examples, the display drivers 155, 170 transmit serial data along the communication channels 155A, 155B, 155C, 155D to the IVI driver circuitry 150. In such examples, the concurrent communications from the display drivers 155, 170 may confirm reception or display of the media on one or more of the displays 160, 165, 175.

Example operations of the IVI system 110 are further described in connection with FIG. 3. Serializing and deserializing media from the media source 145 reduces the number of connections to the displays 160, 165, 175 within the vehicle 100. Also, the serial data streams are capable of accurately traversing relatively large distances across the communication channels 155A, 155B, 155C, 155D.

FIG. 2 is a block diagram of an example of the ADAS system 105 of FIG. 1 including the ADAS hub 115, the peripheral modules 120, 135, and the display 140 of FIG. 1. The example ADAS hub 115 of FIG. 2 includes first example power supply circuitry 205, first example deserializer circuitry 210, first example serializer circuitry 215, second example power supply circuitry 220, second example deserializer circuitry 225, second example serializer circuitry 230, example programmable circuitry 235, and example display interface circuitry 240. The example peripheral module 120 of FIG. 2 includes example serializer circuitry 245, example power regulator circuitry 250, and an example sensor 255.

The power supply circuitry 205 has an output coupled to the communication channel 120A and the deserializer circuitry 210. In some examples, the power supply circuitry 205 has an input coupled to a power storage or an electronic control unit (ECU), which supplies power. In other examples, the power supply circuitry 205 is in the peripheral module 120. In such examples, the power supply circuitry 205 directly supplies power to the peripheral module 120. Alternatively, a different method of powering the peripheral module 120 may be used in in the circuitry described herein.

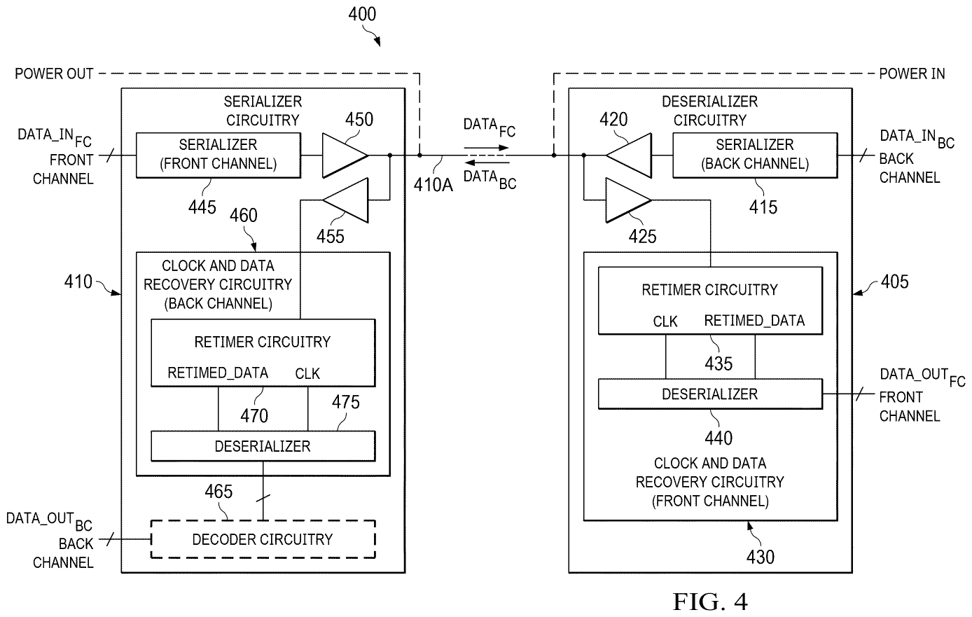

The deserializer circuitry 210 has an input and outputs. The input of the deserializer circuitry 210 is coupled to the communication channel 120A and the power supply circuitry 205. The outputs of the deserializer circuitry 210 are coupled to the serializer circuitry 215 and the programmable circuitry 235. In some examples, the deserializer circuitry 210 communicates with the peripheral module 120 using serial data streams along the communication channel 120A. An example of the deserializer circuitry 210 is further illustrated and described in connection with FIG. 4.

The serializer circuitry 215 has inputs and an output. The inputs of the serializer circuitry 215 are coupled to the deserializer circuitry 210 and the programmable circuitry 235. The output of the serializer circuitry 215 is structured to be coupled to an additional communication channel. In some examples, as illustrated by the dashed lines, the ADAS hub 115 may include the serializer circuitry 215 to connect the ADAS system 105 to external circuitry. In such examples, the serializer circuitry 215 may communicatively couple the ADAS system 105 to another ADAS system, the IVI system 110, storage medium, an ECU, etc. In other examples, the serializer circuitry 215 may be excluded from the ADAS hub 115.

The power supply circuitry 220 has an output coupled to the communication channel 135A and the deserializer circuitry 225. In some examples, the power supply circuitry 220 has an input coupled to a power storage or an ECU, which supplies power. In other examples, the power supply circuitry 220 is in the peripheral module 135. In such examples, the power supply circuitry 220 directly supplies power to the peripheral module 135. Alternatively, a different method of powering the peripheral module 135 may be used in the circuitry described herein.

The deserializer circuitry 225 has an input and outputs. The input of the deserializer circuitry 225 is coupled to the communication channel 135A and the power supply circuitry 220. The outputs of the deserializer circuitry 225 are coupled to the serializer circuitry 230 and the programmable circuitry 235. In some examples, the deserializer circuitry 225 communicates with the peripheral module 135 using serial data streams along the communication channel 135A. An example of the deserializer circuitry 225 is further illustrated and described in connection with FIG. 4.

The serializer circuitry 230 has inputs and an output. The inputs of the serializer circuitry 230 are coupled to the deserializer circuitry 225 and the programmable circuitry 235. The output of the serializer circuitry 230 is structured to be coupled to an additional communication channel. In some examples, as illustrated by the dashed lines, the ADAS hub 115 may include the serializer circuitry 230 to connect the ADAS system 105 to external circuitry. In such examples, the serializer circuitry 230 may communicatively couple the ADAS system 105 to another ADAS system, the IVI system 110, storage medium, an ECU, etc. In other examples, the serializer circuitry 230 may be excluded from the ADAS hub 115.

The programmable circuitry 235 has first inputs, second inputs, and outputs. The first inputs of the programmable circuitry 235 are coupled to the deserializer circuitry 210 and the serializer circuitry 215. The second inputs of the programmable circuitry 235 are coupled to the deserializer circuitry 225 and the serializer circuitry 230. The outputs of the programmable circuitry 235 are coupled to the display interface circuitry 240. In some examples, the programmable circuitry 235 instantiates circuitry based on an execution of machine-readable instructions. In such examples, the programmable circuitry 235 may be one of a central processing unit (CPU), a graphic processing unit (GPU), multi-core processing unit (MCU), etc. Alternatively, the programmable circuitry 235 may be an application specific integrated circuit (ASIC) structured to at least one of store, process, or condition data from the deserializer circuitry 210, 225.

The display interface circuitry 240 has inputs and outputs. The inputs of the display interface circuitry 240 are coupled to the programmable circuitry 235. The outputs of the display interface circuitry 240 are coupled to the display 140. In some examples, the display interface circuitry 240 represents a display driver, which converts data from the programmable circuitry 235 to drive the display 140. In some such examples, the display interface circuitry 240 may include a port and connector specific for driving the display 140, such as a display port, a high-definition multimedia interface (HDMI) port, etc.

The serializer circuitry 245 has inputs and an output. The inputs of the serializer circuitry 245 are coupled to the sensor 255. The output of the serializer circuitry 245 is coupled to the communication channel 120A and the power regulator circuitry 250. In some examples, the serializer circuitry 245 communicates with the ADAS hub 115 using serial data streams along the communication channel 120A. An example of the serializer circuitry 245 is further illustrated and described in connection with FIG. 4.

In the example of FIG. 2, the deserializer circuitry 210 is communicatively coupled to the serializer circuitry 245 by a full duplex wireline connection represented by the communication channel 120A. In some examples, both the deserializer circuitry 210 and the serializer circuitry 245 may receive data from or transmit data on the communication channel 120A. In such examples, the input of the deserializer circuitry 210 and the output of the serializer circuitry 245 are bi-directional. Such an example is further described in connection with FIG. 4.

The power regulator circuitry 250 has an input and an output. The input of the power regulator circuitry 250 is coupled to the communication channel 120A and the serializer circuitry 245. The output of the power regulator circuitry 250 is coupled to the sensor 255. The power regulator circuitry 250 receives power from the power supply circuitry 205. In some examples, such as in FIG. 2, the power regulator circuitry 250 receives power through the communication channel 120A. In other examples, the power supply circuitry 205 may be coupled to the power regulator circuitry 250 by a separate connection or positioned in proximity to the peripheral module 120.

The sensor 255 has an input and outputs. The input of sensor 255 is coupled to the power regulator circuitry 250. The outputs of the sensor 255 are coupled to the serializer circuitry 245. In some examples, the sensor 255 produces data corresponding to a surrounding environment. For example, in FIG. 1, the sensor 255 may be a camera positioned to capture a portion of the environment surrounding the vehicle 100. In another example, the sensor 255 may be an alternative type of sensor for corresponding to characteristics of the surrounding environment of the vehicle 100, such as obstacles.

In example operation, the power supply circuitry 205 supplies power to the power regulator circuitry 250 through the communication channel 120A. In some examples, such as the communication channel 120A being a coaxial connector, the power supply circuitry 205 and the power regulator circuitry 250 implement power over coax (POC). In such examples, the power supply circuitry 205 supplies power (POWER IN) and the power regulator circuitry 250 receives power (POWER OUT). The power regulator circuitry 250 powers the sensor 255, or more generally the peripheral module 120 based on power from the power supply circuitry 205. Similarly, the power supply circuitry 220 may utilize the communication channel 135A to supply power to the peripheral module 135.

The sensor 255 generates data corresponding to the surrounding environment. In some examples, the sensor 255 is a camera that produces multimedia data corresponding to a perspective of the surrounding environment. In another example, the sensor 255 is a lidar device that produces time of flight data corresponding to potential obstacles in the surrounding environment. In yet another example, the sensor 255 is a radar that produces beamforming data corresponding to the surrounding environment. Alternatively, the sensor 255 may be an alternative type of sensor that produces an alternative type of data. In such example operations, the sensor 255 produces sensor data using multiple parallel data paths (also referred to as lines or lanes). The serializer circuitry 245 serializes data of the multiple parallel data paths to produce a serial data stream having a data rate greater than the data rate of the parallel data paths from the sensor 255. The serializer circuitry 245 transmits the serial data stream to the deserializer circuitry 210 using a front channel of the communication channel 120A. Such data of the serial data stream is referred to as front channel data (DATA_{FC_0}).

In example operation, the deserializer circuitry 210 receives the serial data stream after traversing the communication channel 120A. Concurrently, the deserializer circuitry 210 may transmit a serial data stream to the serializer circuitry 245 using a back channel of the communication channel 120A. Such data is referred to as back-channel data (DATA_{BC_0}). In such examples, the front channel data has a data rate greater than the back-channel data to reduce interference. Such multi-directional communications along the communication channel 120A are referred to as full-duplex communications. The deserializer circuitry 210 may use the back channel of the communication channel 120A to control settings of the sensor 255 or verify reception of data on the front channel. Similarly, the peripheral module 135 and the deserializer circuitry 225 may utilize full-duplex communications along the communication channel 135A to exchange front and back-channel data (DATA_{FC_N}, DATA_{BC_N}).

In example operation, the deserializer circuitry 210 deserializes the front channel data to produce multiple parallel data paths. In some examples, the deserializer circuitry 210 may decode identifying data from the front channel data. In such examples, the serializer circuitry 215 may serialize and transmit the front channel data to external circuitry based on the deserializer circuitry 210 decoding identifying data corresponding to external circuitry. The serializer circuitry 215 allows the ADAS system 105 to be coupled to another instance of the ADAS system 105, the IVI system 110, or alternative type of data processing system.

In example operation, the programmable circuitry 235 at least one of processes, stores, or conditions the data of the multiple parallel data paths for the display 140. In some examples, the programmable circuitry 235 combines data from the peripheral modules 120, 135 prior to display. For example, the programmable circuitry 235 may stitch video streams from the peripheral modules 120, 135 to display a larger portion of the surrounding environment. In such examples, the display interface circuitry 240 structures the data from the programmable circuitry 235 to drive the display 140. In some examples, the display interface circuitry 240 is at least one of a column pixel driver or a row pixel driver. The display 140 produces a perceivable representation of the data from at least one of the peripheral modules 120, 135.

Example operations of the serializer and deserializer system of the ADAS system 105 are further described in connection with FIG. 4. Serializing and deserializing data from the peripheral modules 120, 135 reduces the number of connections to the ADAS hub 115. Also, the serial data streams are capable of accurately traversing relatively large distances across the communication channels 120A, 135A.

FIG. 3 is a block diagram of an example of the IVI system 110 of FIG. 1. The IVI system 110 of FIG. 3 includes the media source 145, the IVI driver circuitry 150, the example of the display driver 155, 170, and the displays 160, 165, 175 of FIG. 1. The example IVI driver circuitry 150 of FIG. 3 includes example programmable circuitry 320 and example serializer circuitry 330. The example display driver 155 of FIG. 3 includes example deserializer circuitry 340, example decoder circuitry 350, example display interface circuitry 360, and example serializer circuitry 370.

The programmable circuitry 320 has an input and outputs. The input of the programmable circuitry 320 is coupled to the media source 145. The outputs of the programmable circuitry 320 are coupled to the serializer circuitry 330. In some examples, the programmable circuitry 320 instantiates circuitry based on the execution of machine-readable instructions. In such examples, the programmable circuitry 320 may be one of a CPU, a GPU, an MCU, etc. Alternatively, the programmable circuitry 235 may be an ASIC structured to at least one of store, process, or condition data from the media source 145.

The serializer circuitry 330 has inputs, a first output, and a second output. The inputs of the serializer circuitry 330 are coupled to the programmable circuitry 320. The first output of the serializer circuitry 330 is coupled to the communication channel 155A. The second output of the serializer circuitry 330 is coupled to the communication channel 155B. In some examples, the serializer circuitry 330 communicates with the display driver 155 using serial data streams along the communication channels 155A, 155B. An example of the serializer circuitry 330 is further illustrated and described in connection with FIG. 4. Unlike the serializer circuitry 245 of FIG. 2, the serializer circuitry 330 exchanges data using multiple serial data streams along the communication channels 155A, 155B. In some examples, the serializer circuitry 330 may be illustrated and described as a plurality of instances of the serializer circuitry 330 supporting a single one of the communication channels 155A, 155B. For example, the serializer circuitry 330 may be separated into two instances of the serializer circuitry 330.

The deserializer circuitry 340 has a first input, a second input, and outputs. The first input of the deserializer circuitry 340 is coupled to the communication channel 155A. The second input of the deserializer circuitry 340 is coupled to the communication channel 155B. The outputs of the deserializer circuitry 340 are coupled to the decoder circuitry 350. In some examples, the deserializer circuitry 340 communicates with the IVI driver circuitry 150 using serial data streams along the communication channels 155A, 155B. An example of the deserializer circuitry 340 is further illustrated and described in connection with FIG. 4. Unlike the deserializer circuitry 210, 225 of FIG. 2, the deserializer circuitry 340 exchanges data using multiple serial data streams along the communication channels 155A, 155B. In some examples, the deserializer circuitry 340 may be illustrated and described as a plurality of instances of the deserializer circuitry 340 supporting a single one of the communication channels 155A, 155B. For example, the deserializer circuitry 340 may be separated into two instances of the deserializer circuitry 340, such as the deserializer circuitry 210, 225 of FIG. 2.

The decoder circuitry 350 has inputs, first outputs, and second outputs. The inputs of the decoder circuitry 350 are coupled to the deserializer circuitry 340. The first outputs of the decoder circuitry 350 are coupled to the display interface 360. The second outputs of the decoder circuitry 350 are coupled to the serializer circuitry 370. In some examples, the decoder circuitry 350 is implemented using programmable circuitry or an ASIC. In such examples, the decoder circuitry 350 is structured to route data from the deserializer circuitry 340 to at least one of the display interface 360 or the serializer circuitry 370 based on the decoded portions of the data. Such portions of the data from the deserializer circuitry 340 may be referred to as identifying data, which specifies one or more of the displays 160, 165, 175 to display the media on.

The display interface 360 has inputs, first outputs, and second outputs. The inputs of the display interface 360 are coupled to the decoder circuitry 350. The first outputs of the display interface 360 are coupled to the display 160. The second outputs of the display interface 360 are coupled to the display 165. In some examples, the display interface 360 drives one or more of the displays 160, 165 based on data from the decoder circuitry 350. In some such examples, the display interface 360 may include a port and connector specific for driving the displays, such as a display port, an HDMI port, etc. In the example of FIG. 3, the display interface 360 drives the displays 160, 165. Alternatively, the display driver 155 may include any number of display interfaces 360 for driving any number of displays, such as the displays 160, 165.

The serializer circuitry 370 has inputs, a first output, and a second output. The inputs of the serializer circuitry 370 are coupled to the decoder circuitry 350. The first output of the serializer circuitry 370 is coupled to the communication channel 155C. The second output of the serializer circuitry 370 is coupled to the communication channel 155D. In some examples, the serializer circuitry 370 communicates with the display driver 170 using serial data streams along the communication channels 155C, 155D. An example of the serializer circuitry 370 is further illustrated and described in connection with FIG. 4. Similar to the serializer circuitry 330, the serializer circuitry 370 exchanges data using multiple serial data streams along the communication channels 155C, 155D. In some examples, the serializer circuitry 370 may be illustrated and described as a plurality of instances of the serializer circuitry 370 supporting one of the communication channels 155C, 155D. For example, the serializer circuitry 370 may be separated into two instances of the serializer circuitry 370.

In example operation, the programmable circuitry 320 receives multimedia data from the media source 145. In some examples, the media source 145 is internal to the IVI system 110, such as memory storage, an ECU, a media stream, etc. In other examples, the media source 145 is external to the IVI system 110, such as a wireless connection to a service hosting a multi-media stream. The programmable circuitry 320 identifies one or more of the displays 160, 165, 175 that correspond to the data from the media source 145. In some examples, the programmable circuitry 320 encodes additional data onto the data from the media source 145 corresponding to different operations of the IVI system 110. For example, the programmable circuitry 320 adds identifying data into portions of the data from the media source 145 to specify one or more of the displays 160, 165, 175 that correspond to the media. In such examples, the identifying data may specify the one or more of the displays 160, 165, 175. The programmable circuitry 320 supplies the data to the serializer circuitry 330 for transmission to the display drivers 155, 170.

In example operation, the serializer circuitry 330 receives data from the programmable circuitry 320 on multiple parallel data paths. The serializer circuitry 330 serializes data of the multiple parallel data paths to produce a first and second serial data stream having a data rate greater than the data rate of the parallel data paths from the programmable circuitry 320. The serializer circuitry 330 transmits the first serial data stream to the deserializer circuitry 340 using a front channel of the communication channel 155A. The data of the first serial data stream is referred to as first front channel data (DATA_{FC_0}). The serializer circuitry 330 transmits the second serial data stream to the deserializer circuitry 340 using a front channel of the communication channel 155B. The data of the second serial data stream is referred to as second front channel data (DATA_{FC_1}). Increasing the number of communication channels between the serializer circuitry 330 and the deserializer circuitry 340 increases the possible number of displays the IVI system 110 may support at a given time.

In example operation, the deserializer circuitry 340 receives the first and second serial data streams after traversing the communication channels 155A, 155B. Concurrently, the deserializer circuitry 340 may transmit a first serial data stream to the serializer circuitry 330 using a back channel of the communication channel 155A. The data of the first serial data stream is referred to as first back-channel data (DATA_{BC_0}). Similarly, the deserializer circuitry 340 may transmit a second serial data stream to the serializer circuitry 330 using a back channel of the communication channel 155B. The data of the second serial data stream is referred to as second back-channel data (DATA_{BC_1}). In such examples, the first and second front channel data has a data rate greater than the first and second back-channel data to reduce interference. Such multi-directional communications along the communication channels 155A, 155B are referred to as full-duplex communications. The deserializer circuitry 340 may use the back channel of the communication channels 155A, 155B to verify reception of the first and second front channel data, report errors to the programmable circuitry 320, etc. Similarly, the display driver 170 and the serializer circuitry 370 may utilize full-duplex communications along the communication channels 155C, 155D to exchange third and fourth front channel data (DATA_{FC_2}, DATA_{FC_3}) and third and fourth back-channel data (DATA_{BC_2}, DATA_{BC_3}).

In example operation, the deserializer circuitry 340 deserializes the first and second front channel data to produce multiple parallel data paths. The decoder circuitry 350 decodes the data from the media source 145 from the additional data from the programmable circuitry 320. The decoder circuitry 350 determines which one or more of the displays 160, 165, 175 correspond to the data from the media source 145 based on the decoded data. In some examples, the decoder circuitry 350 supplies the multiple parallel data paths to the serializer circuitry 370 based on a determination that the media does not correspond to the displays 160, 165. In such examples, the serializer circuitry 370 serializes and transmits the third and fourth front channel data to the display driver 170. The display driver 170 may be coupled in series with another instance of the display driver 170 by additional communication channels, such as a fifth and sixth communication channel.

In example operation, the decoder circuitry supplies the multiple parallel data paths to the display interface 360 based on a determination that the media from the media source 145 corresponds to at least one of the displays 160, 165. In some examples, the display interface 360 structures the data from the decoder circuitry 350 to drive one or more of the displays 160, 165. In some examples, the display interface 360 is at least one of a column pixel driver or a row pixel driver. In such examples, at least one of the displays 160, 165 produce a perceivable representation of the media from the media source 145 based on the display interface 360.

Example operations of the serializer and deserializer system of the IVI system 110 are further described in connection with FIG. 4. Serializing and deserializing data from the media source 145 reduces the number of connections to one or more of the displays 160, 165, 175. Also, the serial data streams are capable of accurately traversing relatively large distances across the communication channels 155A, 155B, 155C, 155D.

FIG. 4 is a block diagram of an example serial-deserializer (SerDes) system 400 including example deserializer circuitry 405 and example serializer circuitry 410. The example deserializer circuitry 405 of FIG. 4 includes an example serializer 415, example transmitter circuitry 420, example receiver circuitry 425, and example clock and data recovery (CDR) circuitry 430. The example CDR circuitry 430 of FIG. 4 includes example retimer circuitry 435 and an example deserializer 440. The example serializer circuitry 410 of FIG. 4 includes an example serializer 445, example transmitter circuitry 450, example receiver circuitry 455, example CDR circuitry 460, and example decoder circuitry 465. The example CDR circuitry 460 of FIG. 4 includes example retimer circuitry 470 and an example deserializer 475.

The SerDes system 400 includes an interface between the deserializer circuitry 405 and the serializer circuitry 410 in both the ADAS system 105 of FIGS. 1 and 2 and the IVI system 110 of FIGS. 1 and 3. In the example of the ADAS system 105 of FIG. 2, the deserializer circuitry 405 represents the deserializer circuitry 210 in the ADAS hub 115 and the serializer circuitry 410 represents the serializer circuitry 245 in the peripheral module 120. In the example of the IVI system 110 of FIG. 3, the deserializer circuitry 405 represents the deserializer circuitry 340 in the display driver 155. Also, in the example of the IVI system 110 of FIG. 3, the serializer circuitry 410 represents the serializer circuitry 330 in the IVI driver circuitry 150 or the serializer circuitry 370 in the display driver 155.

The deserializer circuitry 405 is coupled to the serializer circuitry 410 by the communication channel 410A. The deserializer circuitry 405 has inputs (DATA_IN_{BC}) and outputs (DATA_OUT_{FC}). The inputs and outputs of the deserializer circuitry 405 are structured to be coupled to one of the programmable circuitry 235 of FIG. 2 or the decoder circuitry 350 of FIG. 3. The inputs of the deserializer circuitry 405 receive back-channel data for transmission along the communication channel 410A. The outputs of the deserializer circuitry 405 provide front channel data from the communication channel 410A.

The serializer circuitry 410 is coupled to the deserializer circuitry 405 by the communication channel 410A. The serializer circuitry 410 has inputs (DATA_IN_{FC}) and outputs (DATA_OUT_{BC}). The inputs and outputs of the serializer circuitry 410 are structured to be coupled to one of the sensor 255 of FIG. 2 or the programmable circuitry 320 of FIG. 3. The inputs of the serializer circuitry 410 receive front channel data for transmission along the communication channel 410A. The outputs of the serializer circuitry 410 provide back-channel data from the communication channel 410A.

The serializer 415 has inputs and an output. The inputs of the serializer 415 are coupled to the inputs of the deserializer circuitry 405 (DATA_IN_{BC}). The output of the serializer 415 is coupled to the transmitter circuitry 420. In some examples, the serializer 415 is referred to as a back-channel serializer.

The transmitter circuitry 420 has an input and an output. The input of the transmitter circuitry 420 is coupled to the serializer 415. The output of the transmitter circuitry 420 is coupled to the communication channel 410A and the receiver circuitry 425. In some examples, the transmitter circuitry 420 is referred to as a back-channel transmitter.

The receiver circuitry 425 has an input and an output. The input of the receiver circuitry 425 is coupled to the communication channel 410A and the transmitter circuitry 420. The output of the receiver circuitry 425 is coupled to the CDR circuitry 430. In some examples, the receiver circuitry 425 is referred to as a front channel receiver.

The CDR circuitry 430 has an input and outputs. The input of the CDR circuitry 430 is coupled to the receiver circuitry 425. The outputs of the CDR circuitry 430 are coupled to the outputs of the deserializer circuitry 405 (DATA_OUT_{FC}). In some examples, the CDR circuitry 430 is referred to as front channel CDR circuitry.

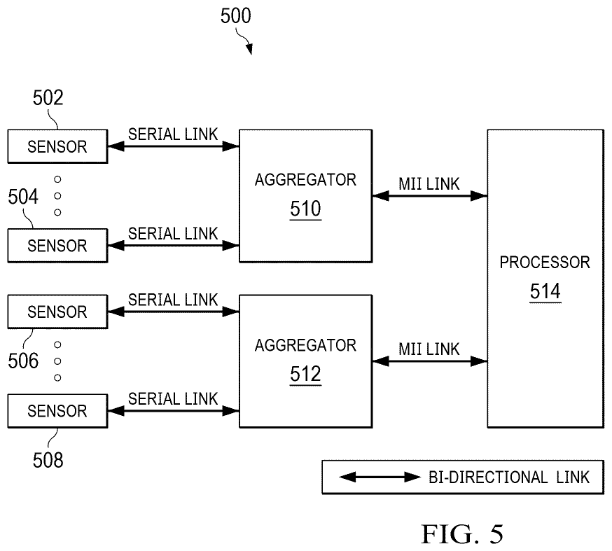

The retimer circuitry 435 has an input, a first output, and a second output. The input of the retimer circuitry 435 is coupled to the receiver circuitry 425. The first and second outputs of the retimer circuitry 435 are coupled to the deserializer 440. An example of the retimer circuitry 435 is further illustrated and described in connection with FIG. 5.

The deserializer 440 has a first input, a second input, and outputs. The first and second inputs of the deserializer 440 are coupled to the retimer circuitry 435. The outputs of the deserializer 440 are coupled to the outputs of the deserializer circuitry 405 (DATA_OUT_{FC}).

The serializer 445 has inputs and an output. The inputs of the serializer 445 are coupled to the inputs of the serializer circuitry 410 (DATA_IN_{FC}). The output of the serializer 445 is coupled to the transmitter circuitry 450. In some examples, the serializer is referred to as a front channel serializer.

The transmitter circuitry 450 has an input and an output. The input of the transmitter circuitry 450 is coupled to the serializer 445. The output of the transmitter circuitry 450 is coupled to the communication channel 410A and the receiver 455. In some examples, the transmitter circuitry 450 is referred to as a front channel transmitter. The transmitter circuitry 420, 450 may include circuitry to impedance match the communication channel 410A to reduce reflections. Also, the transmitter circuitry 420, 450 may have different bandwidths.

The receiver circuitry 455 has an input and an output. The input of the receiver circuitry 455 is coupled to the communication channel 410A and the transmitter circuitry 450. The output of the receiver circuitry 455 is coupled to the CDR circuitry 460. In some examples, the receiver circuitry 455 is referred to as a back-channel receiver.

The CDR circuitry 460 has an input and outputs. The input of the CDR circuitry 460 is coupled to the receiver circuitry 455. The outputs of the CDR circuitry 460 are coupled to the decoder circuitry 465. In some examples, the CDR circuitry 460 is referred to as back-channel CDR circuitry.

The decoder circuitry 465 has inputs and outputs. The inputs of the decoder circuitry 465 are coupled to the CDR circuitry 460. The outputs of the decoder circuitry 465 are coupled to the outputs of the serializer circuitry 410 (DATA_OUT_{BC}). In some examples, as illustrated by the dashed lines, the outputs of the CDR circuitry 460 are directly coupled to the outputs of the serializer circuitry 410 (DATA_OUT_{BC}).

The retimer circuitry 470 has an input, a first output, and a second output. The input of the retimer circuitry 470 is coupled to the receiver circuitry 455. The first and second outputs of the retimer circuitry 470 are coupled to the deserializer circuitry 475. An example of the retimer circuitry 470 is further illustrated and described in connection with FIG. 5.

The deserializer 475 has a first input, a second input, and outputs. The first and second inputs of the deserializer 475 are coupled to the retimer circuitry 470. The outputs of the deserializer 475 are coupled to the decoder circuitry 465. In some examples, as illustrated by the dashed lines, the outputs of the deserializer 475 are directly coupled to the outputs of the serializer circuitry 410 (DATA_OUT_{BC}).

In example operation, the deserializer circuitry 405 receives back-channel data (DATA_{BC}) via multiple data paths from an external data source, such as the programmable circuitry 235 or the decoder circuitry 350. The serializer 415 produces a back-channel serial data stream based on the back-channel data. The transmitter circuitry 420 transmits the back-channel data to the serializer circuitry 410 across the communication channel 410A. Similarly, the serializer circuitry 410 receives front channel data (DATA_{FC}) via multiple data paths from an external data source, such as the sensor 255 or the programmable circuitry 320. The serializer 445 produces a front channel serial data stream based on the front channel data. The transmitter circuitry 420 transmits the front channel data to the deserializer circuitry 405 across the communication channel 410A. In some examples, the data rates of the transmissions of the front and back-channel data are different to prevent interference. In some examples, the bandwidth of the transmitter circuitry 420, which transmits the back-channel data, is modified to reduce non-linear gain contributions of the communication channel 410A. The serializers 415, 445 and the transmitter circuitry 420, 450 support full-duplex data transmissions along the communication channel 410A.

In example operation, the deserializer circuitry 405 receives the front channel data (DATA_{FC}) after propagating along the communication channel 410A. The receiver circuitry 425 produces a serial data stream representing the front channel data based on signals from the communication channel 410A. In some examples, the receiver circuitry 425 isolates the communication channel 410A from the CDR circuitry 430. The deserializer circuitry 405 may include echo cancelation circuitry to reduce contributions of the back-channel data from signals received by the transmitter circuitry 420. Similarly, the serializer circuitry 410 receives the back-channel data (DATA_{BC}) after propagating along the communication channel 410A. The receiver circuitry 455 produces a serial data stream representing the back-channel data based on signals from the communication channel 410A. In some examples, the receiver circuitry 425 isolates the communication channel 410A from the CDR circuitry 430. The serializer circuitry 410 may include echo cancelation circuitry to reduce contributions of the front channel data from signals received by the transmitter circuitry 450. Also, the receiver circuitry 425, 455 terminates currents of the communication channel 410A.

In example operation, the CDR circuitry 430 receives the front channel data from the receiver circuitry 425. The retimer circuitry 435 retimes the front channel data to produce retimed front channel data (RETIMED_DATA). The retimer circuitry 435 produces a clock signal (CLK), which represents an accurate sampling time of the retimed front channel data. The deserializer 440 receives the retimed front channel data and the clock signal from the retimer circuitry 435. The deserializer 440 produces multiple parallel data paths representing the front channel data. The outputs of the deserializer circuitry 405 provide the front channel data to external circuitry, such as the programmable circuitry 235 or the decoder circuitry 350. Similarly, the CDR circuitry 460 receives the back-channel data from the receiver circuitry 455. The retimer circuitry 435 produces retimed back-channel data and a clock signal based on the retiming of the back-channel data to the clock signal. The deserializer 475 receives the retimed back-channel data and the clock signal from the retimer circuitry 470. The deserializer 475 produces multiple parallel data paths representing the back-channel data. In some such example operations, the decoder circuitry 465 decodes portions of the back-channel data prior to the outputs of the serializer circuitry 410 supplying the back-channel data to external circuitry, such as the sensor 255 or the programmable circuitry 320.

Serializing and deserializing front and back-channel data reduces the number of connections that need to traverse relatively large distances of the communication channel 410A. The serial data streams are capable of accurately traversing relatively large distances across the communication channels 410A.

FIG. 5 illustrates an example system 500 that utilizes bi-directional links, such as bidirectional serial links, SerDes links, FPD links, etc., to transmit data of a first format that has been encapsulated to a second format. The system 500 includes example sensors 502, 504, 506, 508, example aggregators 510, 512, and an example processor 514. Although the system 500 of FIG. 5 includes a particular number of sensors, aggregators, and processors, the system 500 may include any number of sensors, aggregators, or processors.

The sensors 502, 504, 506, 508 are devices that sense an attribute of an environment and generate data corresponding to the attribute. For example, the sensors 502, 504, 506, 508 may include radar sensors, temperature sensors, humidity sensors, force sensors, motion sensors, etc. The sensors 502, 504, 506, 508 generate data packets corresponding to the sensed data to be transmitted to the processor 514. The data packets are generated based on a first format/standard/protocol. For example, the sensors 502, 504, 506, 508 may be Ethernet-based sensors that utilize a MAC layer to generate Ethernet-based data packets (also referred to as MAC frames, MAC packets, or MAC datagrams). As further described below, the sensors 502, 504, 506, 508 convert/encapsulate the data packets of the first format to a second format/standard/protocol. For example, because the links that couple the sensors, 502, 504, 506, 508 to the aggregators 510, 512 are bi-directional links, such as SerDes links, FPD links, or any other bi-directional serail links, the sensors 502, 504, 506, 508 include components to convert/encapsulate the Ethernet-based data packets into serial data packets so that the packets can be sent to the processor 514 using the bi-directional serial links. Also, the sensors 502, 504, 506, 508 include components to de-covert/decapsulate incoming data of the second format (e.g., serial) to the first format (e.g., Ethernet), so that the processor 514 can transmit serial-based data packets to the sensor and the sensor can convert the serial-based data packets to Ethernet-based data packets for the sensor to process. In some examples, one or more of the sensors 502, 504, 506, 508 could be used to implement the sensors 255 of FIG. 2. The sensors 502, 504 each include a terminal that is coupled to the aggregator 510 with a bidirectional link and sensors 506, 508 each include a terminal that is coupled to the aggregator 512.

The aggregators 510, 512 of FIG. 5 aggregates data from multiple sensors to provide to the processor 514. In some examples, the aggregators 510, 512 are used to reduce power consumption. Also, the aggregators 510, 512 may include a physical layer (PHY) that provides the Ethernet-based data packets to a MAC layer of the processor 514. In some examples, the aggregators 510, 512 can be removed and the sensors can connect directly to the processor 514 via the bi-directional links. The aggregators 510, 512 include multiple terminals. For example, the aggregator 510, 512 include terminals coupled to each connected sensor via serial links and a terminal coupled to the processor 514 via a media independent interface (MII). An MII is a bi-directional interface with two separate uni-directional pins.

The processor 514 of FIG. 5 receives serial-based data packets from the sensors 502, 504, 506, 508 via the aggregator 510 and processes the data packets to identify the information sensed by the sensors 502, 504, 506, 508. In some examples, the processor 514 may decode/decapsulate the serial data packet to convert the data packet back into an Ethernet-based data packet for processing. Also, the processor 514 can generate Ethernet data packets corresponding to commands to send to one or more of the sensors 502, 504, 506, 508, convert the Ethernet data packets to serial data packets, and transmit the serial data packets to one or more of the sensors 502, 504, 506, 508. In this manner, the one or more sensors 502, 504, 506, 508 can decode/decapsulate the serial data packets into Ethernet data packets for the sensor to process. The processor 514 is coupled to the aggregators 510, 512 via the bi-directional links.

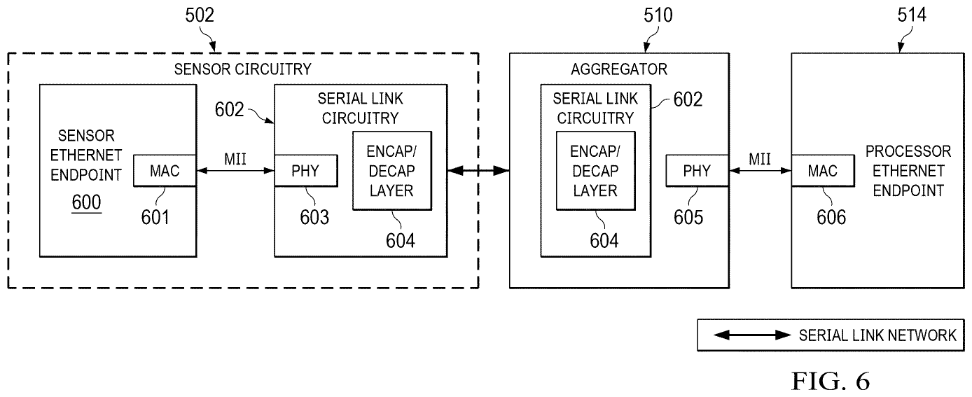

FIG. 6 is an example block diagram of the sensor circuitry 502, the aggregator 510 and the processor 514 of FIG. 5. The sensor circuitry 502 includes an example sensor Ethernet endpoint 600, an example MAC layer 601, example serial link circuitry 602, an example PHY layer 603, and an example encapsulation/decapsulation layer 604. The aggregator 510 includes the serial link circuitry 602, the example encapsulation/decapsulation layer 604, and an example PHY layer 605. The processor 514 includes an example MAC layer 606. The serial link circuitry 602 can be implemented in any one or more of the serialized circuitries 215, 230, 245, 330, 370, 415, 445 or deserializer circuitries 210, 225, 340, 440, 475 of FIGS. 2-4

The sensor Ethernet endpoint 600 of FIG. 2 generates Ethernet data packets based on sensed data. For example, if the sensor circuitry 502 corresponds to a sensor temperature, the sensor Ethernet endpoint 600 generates Ethernet data packets with sensed temperature measurements. The sensor Ethernet endpoint 600 includes the MAC layer 601 to transmit the Ethernet data packets to the PHY 603 of the serial link circuitry 602 via a media independent interface (MII). Also, the MAC layer 601 may receive Ethernet-based data packets or pause frames from the PHY 603, as further described below. In response to receiving a pause frame, the MAC 601 stops/pauses/refrains from sending additional Ethernet data packets to the PHY 603 for a predefined duration of time. As further described below, the PHY 603 may transmit a pause frame to avoid packet loss within the serial link circuitry 602.

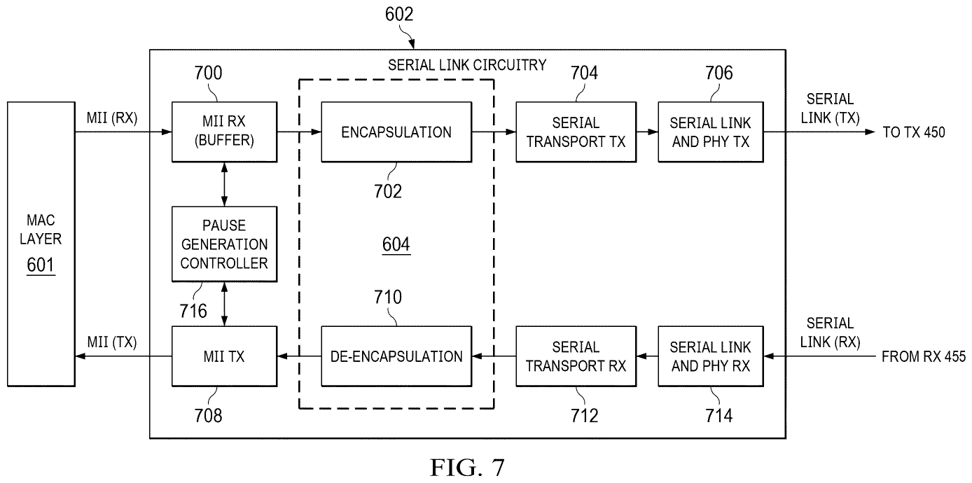

The serial link circuitry 602 receives Ethernet data packets from MAC layer 601 of the sensor Ethernet endpoint 600 and stores the data packets in an output buffer until the data packet is ready to be sent to the aggregator 510 via the bidirectional link. The data packet may be ready to be sent to the aggregator 510 based on one or more of the scheduling or baud rate of the bi-directional link. As further described below, the encapsulation/decapsulation layer 604 encapsulates the Ethernet-based data packet from an Ethernet format into a serial-based format so that the data packet can be transmitted to the processor 514 via a bi-directional link corresponding to a serial protocol. Also, the serial link circuitry 602 receives serial data from the processor 514 and decapsulates the data packet in the serial format to the Ethernet format to be consumed by the sensor Ethernet endpoint 600. Also, the serial link circuitry 602 includes buffer monitoring circuitry to monitor the amount of data packets in the input or output buffer. In this manner, if the amount of data packets in the input buffer or the output buffer is above a threshold, the serial link circuitry 602 controls the MAC layer 601 of the sensor Ethernet endpoint 600 or the MAC layer 606 of the processor 514 to pause the sending of additional data packets to avoid packet loss. The serial link circuitry 602 is further described below in conjunction with FIG. 7.

The PHY 603 of FIG. 6 implements hardware send and receive function of Ethernet data packets or frames. For example, the PHY 603 receives Ethernet-based data packets from the MAC 601 of the sensor Ethernet endpoint 600 and causes them to be transmitted to the processor via a physical data link (e.g., the bi-directional link). In some examples, the PHY 603 provides the Ethernet data packets to the encapsulation/decapsulation layer 604. In some examples, the encapsulation/decapsulation layer 604 is incorporated into the PHY 603. The PHY 603 is coupled to the MAC layer 601 via the MII.

After a data packet is ready to be transmitted to the processor 514, the encapsulation/decapsulation layer 604 of FIG. 6 encapsulates the Ethernet-based data packet (also referred to as a datagram, a data frame, a frame, etc.) to change the Ethernet-based format of the data packet into a serial-based format. In this manner, the serial link circuitry 602 can transmit the encapsulated data packet via the bi-directional serial link to the processor endpoint 514. Also, after a data packet configured in a serial format is received via the bi-directional link, the encapsulation/decapsulation layer 604 decapsulates the serial data packet into an Ethernet-based format. In this manner, the Ethernet-based data packet can be transmitted to the MAC layer 601 of the sensor Ethernet endpoint 600 to be processed.

The serial link circuitry 602, encapsulation/decapsulation layer 604, and PHY 605 of the aggregator 510 operate in a similar manner as the serial link circuitry 602, the encapsulation/decapsulation layer 604, and PHY 603 of the sensor circuitry 502. Also, the MAC 606 of the processor 514 operates in a similar manner as the MAC 601 of the sensor Ethernet endpoint 600. In some examples, if the aggregator 510 is not included in the system and the sensor circuitry 502 is coupled directly to the processor 514, the serial link circuitry 602, the encapsulation/decapsulation layer 604, and the PHY 605 of the aggregator 510 could be implemented within the processor 514.

FIG. 7 is a block diagram of the example serial link circuitry 602 in the sensor circuitry 502 of FIG. 6. The serial link circuitry 602 of FIG. 7 includes an example output buffer 700, an example encapsulation controller 702, example serial transport transmission circuitry 704, example serial link and PHY transmitter circuitry 706, an example input buffer 708, an example decapsulation controller 710 an example serial transport receiver circuitry 712, and example serial link and PHY receiver circuitry 714. FIG. 7 further includes the MAC layer 601 of the sensor Ethernet endpoint 600 of FIG. 6. Also, the encapsulation controller 702 and the decapsulation controller 710 implement the encapsulation/decapsulation layer 604 of FIG. 6. Although the serial link circuitry 602 of FIG. 7 is described in conjunction with the sensor circuitry 502 of FIG. 6, the serial link circuitry 602 may be described in conjunction with the serial link circuitry 602 of the aggregator 510 by replacing the MAC 601 with the MAC 606 and coupling the serial links to the transmitter 450 and receiver 455 of FIG. 4.

The output buffer 700 of FIG. 7 receives Ethernet-based/MAC-based packets/frames/datagrams corresponding to an Ethernet/MAC-based format from the MAC layer 601. The output buffer 700 stores the received data packets until the serial link circuitry 602 is ready to provide the data packet via the transmitter 450. For example, the serial link circuitry 602 provides data packets based on the baud rate or schedule associated with the bi-directional link. Accordingly, received data packets are stored in the buffer 700 until they are scheduled to be transmitted based on the serial protocol. After an Ethernet/Mac data packet is ready to be transmitted, the buffer 700 provides the data packet to the encapsulation controller 702. The output buffer 700 has an input, an output, and a terminal. The input of the output buffer 700 is coupled to the MAC layer 601 via a MII. The output of the buffer 700 is coupled to the encapsulation controller 702. The terminal of the buffer 700 is coupled to the pause generation controller 716.

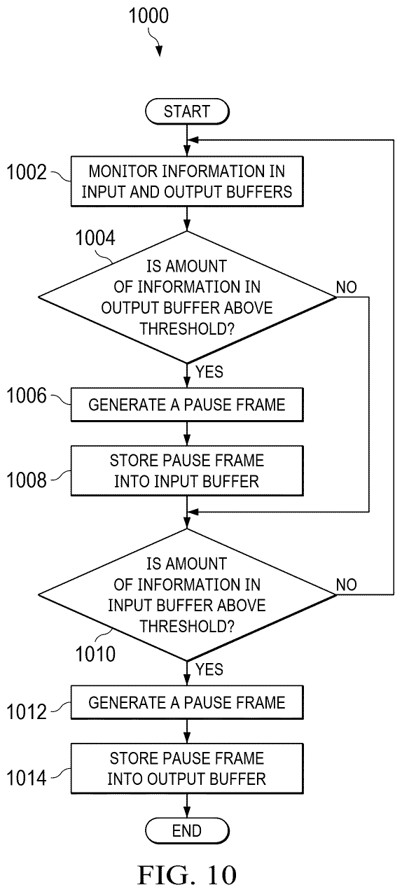

The encapsulation controller 702 of FIG. 7 encapsulates, converts, or encodes the data packet in the first format (e.g., Ethernet-based format) to a second format (e.g., a serial format) that corresponds to transmission via a serial bidirectional link. An example of a data packet in a first format and a second format is further described below in conjunction with FIGS. 9A and 9B. After encapsulating the Ethernet-based data packet to a serial-based data packet, the encapsulation controller 702 provides the serial-based data packet to the serial transport transmitter circuitry 704. The encapsulation controller 702 includes an input and an output. The input of the encapsulation controller 702 is coupled to the output buffer 700. The output of the encapsulation controller 702 is coupled to the serial transport transmitter circuitry 704.

The serial transport transmitter circuitry 704 of FIG. 7 generates the bits to be transmitted based on the serial-based data packet by segmenting the serial-based data into segments. The serial transport transmitter circuitry 704 includes an input and an output. The input of the serial transport transmitter circuitry 704 is coupled to the encapsulation controller 702. The output of the serial transport transmitter circuitry 704 is coupled to the serial link and PHY transmitter circuitry 706.

The serial link and PHY transmitter circuitry 706 of FIG. 7 encodes the generated bits of the serial transport transmitter circuitry 704 into the PHY layer for transmission over the PHY layer using a modulation protocol, such as non-return to zero (NRZ) modulation. The PHY transmitter circuitry 706 includes an input and an output. The input of the serial link and PHY transmitter circuitry 706 is coupled to the serial transport transmitter circuitry 704. The output of the serial link and PHY transmitter circuitry 706 is coupled to the transmitter 450 of FIG. 4.

The input buffer 708 of FIG. 7 stores input data packets received at the receiver 455 that have been converted from a serial formal to an Ethernet-based or MAC-based format until the serial link circuitry 602 is ready to provide the data packet via the transmitter 450. For example, the buffer 708 can receive data packets from the receiver 455 while the MAC layer 601 is not ready to receive the data packets. The MAC layer 601 may not be ready to receive data packets because the MAC layer 601 is performing another task, for example. Accordingly, received data packets are stored in the buffer 708 until they are scheduled to be provided to the MAC layer 601 according to the Ethernet protocol. After an Ethernet/MAC-based data packet is ready to be transmitted to the MAC layer 601, the buffer 708 provides the data packet to the MAC layer 601. The output buffer 708 has an input, an output, and a terminal. The output of the input buffer 708 is coupled to the MAC layer 601 via a MII. The input of the buffer 708 is coupled to the decapsulation controller 710. The terminal of the buffer 708 is coupled to the pause generation controller 716.

The decapsulation controller 710 of FIG. 7 decapsulates, converts, or decodes, the data packet in the second format (e.g., a serial format) to the second format (e.g., an Ethernet format) that corresponds to the format used by the sensor Ethernet endpoint 600. After decapsulating the serial-based data packet to an Ethernet-based data packet, the decapsulation controller 710 provides the Ethernet-based data packet to the input buffer 708 for temporary storage until being transmitted to the MAC layer 601. The decapsulation controller 710 includes an input and an output. The output of the decapsulation controller 710 is coupled to the input buffer 708. The input of the decapsulation controller 710 is coupled to the serial transport receiver circuitry 712.

The serial transport receiver circuitry 712 of FIG. 7 combines the bit segments of the serial-based data into full serial data packets. The serial transport receiver circuitry 712 includes an input and an output. The output of the serial transport receiver circuitry 712 is coupled to the decapsulation circuitry 710. The input of the serial transport receiver circuitry 712 is coupled to the serial link and PHY receiver circuitry 714.

The serial link and PHY receiver circuitry 714 of FIG. 7 decodes a received serial data packet using a demodulation protocol that corresponds to the encoding of the serial link and PHY transmitter circuitry of the device that transmitted the serial data packet. The serial link and PHY receiver circuitry 714 includes an input and an output. The input of the serial link and PHY receiver circuitry 714 is coupled to the receiver 455. The output of the serial link and PHY receiver circuitry 714 is coupled to the serial transport receiver circuitry 712.

The pause generation controller 716 of FIG. 7 monitors the amount of data packets stored in the output buffer 700 and the input buffer 708. For example, the pause generation controller 716 can determine if the amount of available space left in either buffer 700, 708 or the number of data packets stored in either buffer 700, 708 is above a threshold. Because the rate at which the MAC layer 601 provides data may be different (e.g., faster) than the rate at which the transmitter 450 can output data via the bi-directional link, without interference, the output buffer 700 may become full and begin to drop packets, thereby leading to output packet loss. The pause generation controller 716 determines whether the output buffer 700 is almost full based on a threshold amount of stored data, a threshold amount of available space, a threshold number of stored data packets, etc.). Accordingly, if the pause generation controller 716 determines that the output buffer 700 is almost full, the pause generation controller 716 generates a pause frame and stores the pause frame in the input buffer 708. Because the input buffer 708 provides stored data to the MAC layer 601, the pause generation controller 716 stores the pause frame in the input buffer 708. The stored pause frame is provided to the MAC layer 601. Based on receiving a pause frame, the MAC layer 601 pauses the output or generation of Ethernet-based data to allow time for the output buffer 700 to provide the stored data packets and avoid output packet loss. In this manner, the serial link circuitry 602 can ensure that rate matching is achieved to eliminate packet loss regardless of differences in baud rates of the Ethernet protocol and the serial protocol.

Although adding pause frames to the input buffer 708 can prevent output packet loss by allowing time for the output buffer 700 to provide the stored packets before receiving additional packets from the MAC layer 601, adding frames into the input buffer 708 can cause the input buffer 708 to reach capacity, thereby increasing the risk of input packet loss. Accordingly, the pause generation controller 716 can also monitor the input buffer 708 to determine if the amount of available space left in either buffer 700, 708 or the number of data packets stored in either buffer 700, 708 is above a threshold. If the pause generation controller 716 determines that the input buffer 708 is almost full, the pause generation controller 716 generates a pause frame and stores the pause frame in the output buffer 700. Because the output buffer 700 provides stored data to the MAC layer 606 of the processor 514 via the bidirectional link and the aggregator 510, the pause generation controller 716 stores the pause frame in the input buffer 708. The stored pause frame is provided to the MAC layer 606 of the processor 514. Based on receiving a pause frame, the processor 514 pauses the output or generation of data to be sent to the sensor circuitry 502 to allow the input buffer 708 time to provide the stored data packets and avoid input packet loss. In this manner, the processor 514 pauses the output of additional data to the sensor device so that the input buffer of the sensor circuitry 502 does not fill and result in packet drop. Accordingly, the serial link circuitry 602 provides application agnostic communication links that can utilize different protocols in a system that eliminates packet loss at the input and output of a sensor.

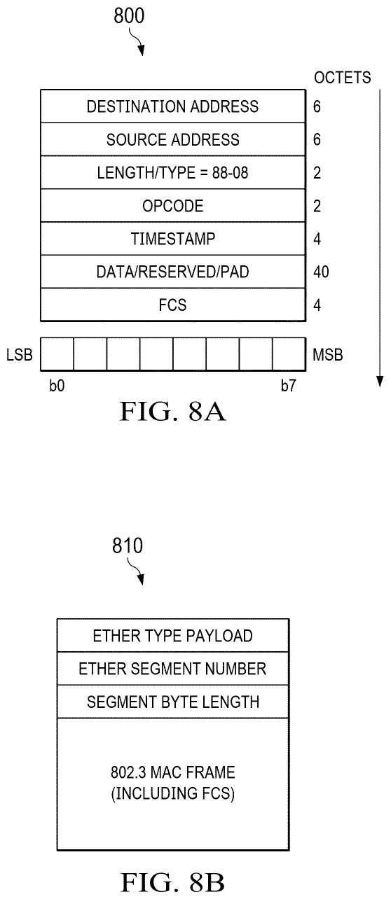

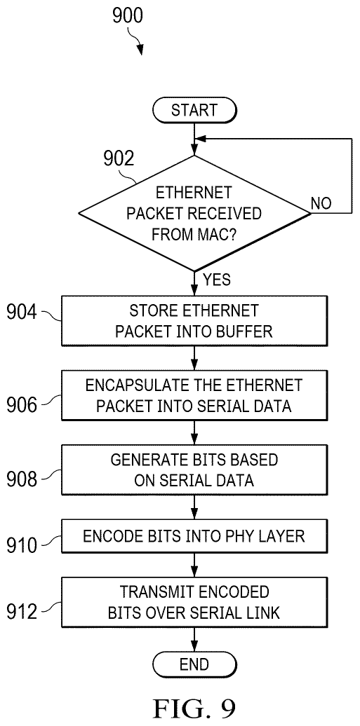

FIG. 8A illustrates an example Ethernet-based data packet 800 (also referred to as an Ethernet-based or MAC-based data frame, datagram, etc.). The Ethernet-based data packet 800 includes information including destination address, source address, length of packet or type of packet, opcode, a timestamp, a data portion, and a frame check sequence (FCS). Each portion of information is structured into different amounts of octets within the frame. The example Ethernet-based data packet 800 corresponds to a data packet that may be output by the MAC 601 and stored in the output buffer 700 or the output of the decapsulation controller 710 and stored in the input buffer 708 to be provided to the MAC 601. As described above, the encapsulation controller 702 converts the Ethernet-based data packet 800 into a serial data packet corresponding to the serial format, which is further described below in conjunction with FIG. 8B.

FIG. 8B illustrates an example serial format data packet 810 (also referred to as a data frame) that has encapsulated the Ethernet-based data packet 800 of FIG. 8A. The serial format data packet 810 includes information such as Ether type payload, ether segment number, segment byte length, and MAC frame information. The Ether type payload indicates the protocol type for the payload or the data included within the data packet. The ether segment number is a unique identifier assigned to the segment. The MAC frame information includes some or all of the information within the Ethernet-based data packet 800. As described above, the serial format data packet 810 is structured to be able to segment the serial format data packet 810 into segments and transmit via the bi-directional link based on the serial protocol.

FIG. 9 is a flowchart representative of example machine-readable instructions or example operations 900 that may be at least one of executed, instantiated, or performed by programmable circuitry to encapsulate a data packet from a first format to a second format. Although the example of FIG. 9 is described in conjunction with encapsulation, a similar process can be followed to decapsulate a data packer from the second format to the first format, as described above in conjunction with FIG. 7. The example machine-readable instructions or the example operations 900 of FIG. 9 begin at block 902. If, at block 902, an Ethernet packet is not received from the MAC layer 601 (block 902: NO), control returns to block 902 until an Ethernet packet has been received.

If, at block 902, an Ethernet packet has been received from the MAC layer 601 (block 902: YES), the output buffer 700 stores the Ethernet packet (block 904). As further described below in conjunction with FIG. 10, the pause generation controller 716 monitors the amount of data stored in the output buffer 700 to ensure that output packet loss does not occur. At block 906, the encapsulation controller 702 receives the data packet from the output buffer 700 and encapsulates the ethernet packed into serial data. The encapsulation controller 702 may pull the data based on the timing of the serial protocol or based on the baud rate of the bi-directional link. At block 908, the serial transport transmitter circuitry 704 generates bits based on the serial data, as further described above in conjunction with FIG. 7. At block 910, the serial link and PHY transmitter circuitry 706 encodes the bits into the PHY layer, as further described above in conjunction with FIG. 7. At block 912, the transmitter 450 transmits the encoded bits over the bi-directional serial link.

FIG. 10 is a flowchart representative of example machine-readable instructions or example operations 1000 that may be at least one of executed, instantiated, or performed by programmable circuitry to prevent input or output packet loss based on communicating encapsulating data packets between endpoints. The example machine-readable instructions or the example operations 1000 of FIG. 10 begin at block 1002, at which the pause generation controller 716 monitors the amount of information or data packets stored in the output buffer 700 and the input buffer 708.

At block 1004, the pause generation controller 716 determines if the amount of information in the output buffer 700 is above a threshold. The threshold may be based on the size of the buffer 700. For example, the threshold may be set so that one or two more data packets can still be stored in the buffer 700 before the buffer 700 is full. If the pause generation controller 716 determines that the amount of information in the output buffer 700 is not above the threshold (block 1004: NO), control continues to block 1010. If the pause generation controller 716 determines that the amount of information in the output buffer 700 is above the threshold (block 1004: YES), the pause generation controller 716 generates a pause frame (block 1006). At block 1008, the pause generation controller 716 stores the pause frame into the input buffer 708. As described above, inputting a pause frame into the input buffer 708 results in the pause frame being sent to the MAC layer 601. The MAC layer 601 processes the pause frame and pause generation or transmission of additional Ethernet-based data packets to the output buffer 700 for a threshold amount of time. This gives time for the output buffer 700 to continue to output data packets to the transmitter 450 and avoid output packet loss.

At block 1010, the pause generation controller 716 determines if the amount of information in the input buffer 708 is above a threshold. The threshold may be based on the size of the buffer 708. For example, the threshold may be set so that one or two more data packets can still be stored in the buffer 708 before the buffer 708 is full. If the pause generation controller 716 determines that the amount of information in the input buffer 708 is not above the threshold (block 1010: NO), control returns to block 1002. If the pause generation controller 716 determines that the amount of information in the input buffer 708 is above the threshold (block 1010: YES), the pause generation controller 716 generates a pause frame (block 1012). At block 1014, the pause generation controller 716 stores the pause frame into the output buffer 700. As described above, inputting a pause frame into the output buffer 700 results in the pause frame being sent to the endpoint (e.g., the processor 514) via the bidirectional link. The end device (e.g., the processor 514) processes the pause frame and pause generation or transmission of data packets to the sensor 502 for a threshold amount of time. This gives time for the input buffer 708 to continue to provide data packets to the MAC layer 601 and avoid input packet loss.

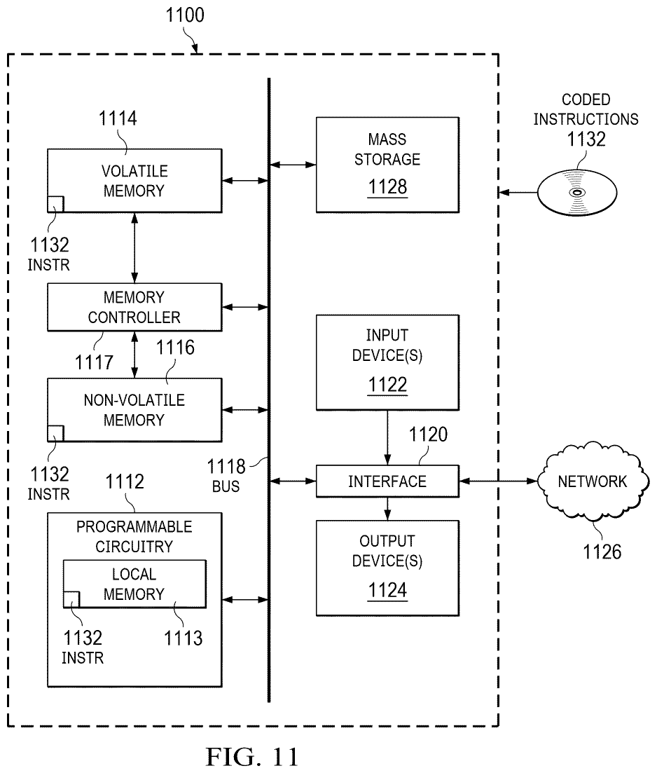

FIG. 11 is a block diagram of an example programmable circuitry platform 1100 structured to one or a combination of execute or instantiate one or more of the example machine-readable instructions or the example operations of FIGS. 9-10 to implement one or more components of the serial link circuitry 602 of FIGS. 2-4, 6 and 7. The programmable circuitry platform 1100 can be, for example, a server, a personal computer, a computing system for a vehicle (e.g., an automobile), a workstation, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, or microcontrollers from any desired family or manufacturer. The programmable circuitry 1112 may be implemented by one or more semiconductor based (e.g., silicon based) devices. In this example, the programmable circuitry 1112 implements the one or more components of the serial link circuitry 602 of FIGS. 2-4, 6 and 7.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 1116 may be implemented by one or a combination of flash memory or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter one of or a combination of data or commands into the programmable circuitry 1112. The input device(s) 1122 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 1124 are also connected to the interface circuitry 1120 of the illustrated example. The output device(s) 1124 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 1120 of the illustrated example, thus, includes one of or a combination of a graphics driver card, a graphics driver chip, or graphics processor circuitry such as a GPU.

The interface circuitry 1120 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store one or more firmware, software, or data. Examples of such mass storage discs or devices 1128 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 1132, which may be implemented by the machine-readable instructions of FIGS. 9-10, may be stored in one of or a combination of the mass storage device 1128, in the volatile memory 1114, in the non-volatile memory 1116, or on at least one non-transitory computer readable storage medium such as a CD or DVD which may be removable.

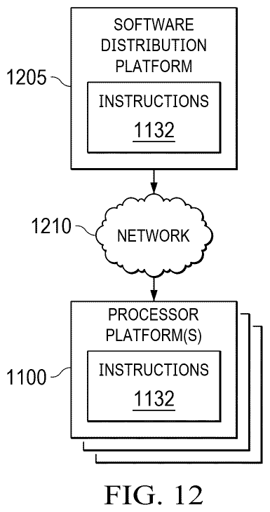

A block diagram illustrating an example software distribution platform 1205 to distribute software such as the example machine-readable instructions 1132 of FIG. 11 to other hardware devices (e.g., one or more hardware devices owned or operated by third parties from the owner or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity at least one of owning or operating the software distribution platform 1205. For example, the entity that at least one of owns or operates the software distribution platform 1205 may be at least one of a developer, a seller, or a licensor of software such as the example machine-readable instructions 1132 of FIG. 11. The third parties may be consumers, users, retailers, OEMs, etc., who one of or a combination of purchase or license the software for at least one of use, re-sale, or sub-licensing. In the illustrated example, the software distribution platform 1205 includes one or more servers and one or more storage devices. The storage devices store the machine-readable instructions 1132, which may correspond to the example machine-readable instructions of FIGS. 9-10, as described above. The one or more servers of the example software distribution platform 1205 are in communication with an example network 1210, which may correspond to any one or more of the Internet or any of the example networks described above. In some examples, the one or more servers are responsive to requests to transmit the software to a requesting party as part of a commercial transaction. Payment for at least one of the delivery, sale, or license of the software may be handled by the one or more servers of at least one of the software distribution platform or by a third-party payment entity. The servers enable one or more purchasers or licensors to download the machine-readable instructions 1132 from the software distribution platform 1205. For example, the software, which may correspond to the example machine-readable instructions of FIGS. 9-10, may be downloaded to the example programmable circuitry platform 1100, which is to execute the machine-readable instructions 1132 to implement the serial link circuitry 602 of FIGS. 2-4, 6 and 7. In some examples, one or more servers of the software distribution platform 1205 periodically at least one of offer, transmit, or force updates to the software (e.g., the example machine-readable instructions 1132 of FIG. 11) to ensure improvements, patches, updates, etc., are distributed and applied to the software at the end user devices. Although referred to as software above, the distributed “software” could alternatively be firmware.

While an example manner of implementing the serial link circuitry 602 of FIGS. 2-4 and 6 is illustrated in FIG. 7, one or more of the elements, processes, or devices illustrated in FIG. 7 may be combined, divided, re-arranged, omitted, eliminated, or implemented in any other way. Further, the components of the serial link circuitry 602 of FIG. 7 may be implemented by hardware alone or by hardware in combination with software and firmware. Thus, for example, any of the encapsulation controller 702, the serial transport transmitter circuitry 704, the serial link and PHY transmitter circuitry 706, the decapsulation controller 710, the serial transport receiver circuitry 712, the serial link and PHY receiver circuitry 714, or, more generally, the serial link circuitry 602 of FIG. 7, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example serial link circuitry 602 of FIGS. 2-4, 6 and 7 may include one or more elements, processes, or devices in addition to, or instead of, those illustrated in FIGS. 2-4, 6, or 7, or may include more than one of any or all of the illustrated elements, processes and devices.

Flowchart(s) representative of example machine-readable instructions, which may be executed by programmable circuitry to at least one of implement or instantiate the serial link circuitry 602 of FIGS. 2-4, 6 and 7 or representative of example operations which may be performed by programmable circuitry to at least one of implement or instantiate the serial link circuitry 602 of FIGS. 2-4, 6 and 7, are shown in FIGS. 9-10. The machine-readable instructions may be one or more executable programs or portion(s) of one or more executable programs for execution by programmable circuitry such as the programmable circuitry 1112 shown in the example processor platform 1100 described above in connection with FIG. 11 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., at least one of software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9-10, many other methods of implementing the example serial link circuitry 602 of FIGS. 2-4, 6 and 7 may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices, wherein the parts responsive to being decrypted, decompressed, or combined from a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C-sharp, Perl, Python, JavaScript, HyperText Markup Language (HTML), Structured Query Language (SQL), Swift, etc.

As mentioned above, the example operations of FIGS. 9-10 may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

When reading any of the apparatus or system claims of this patent to cover a purely software or firmware implementation, at least one of the processor cores 104 or any component of the serial link circuitry 602 of FIG. 7 is/are hereby expressly defined to include a non-transitory computer readable storage device or storage disk such as a memory, a digital versatile disk (DVD), a compact disk (CD), a Blu-ray disk, etc., including the software or firmware. Further still, one or more of one or more of the processor cores 106 or the components of the serial link circuitry 602 may include one or more elements, processes or devices in addition to, or instead of, those illustrated in FIGS. 1-2, or may include more than one of any or all of the illustrated elements, processes, and devices. As used herein, the phrase “in communication,” including variations thereof, encompasses direct communication or indirect communication through one or more intermediary components, and does not require direct physical (e.g., wired) communication or constant communication, but rather also includes selective communication at one or more of periodic intervals, scheduled intervals, aperiodic intervals, or one-time events.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein to identify multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having,” and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The terms “couple,” “coupled,” “couples,” and variants thereof, as used herein, may cover connections, communications, or signal paths that enable a functional relationship consistent with this description. For example, if device A generates a signal to control device B to perform an action, if a first example device A is coupled to device B, or if a second example device A is coupled to device B through intervening component C if intervening component C does not substantially alter the functional relationship between device A and device B, such that device B is controlled by device A via the control signal generated by device A. Moreover, the terms “couple,” “coupled”, “couples”, or variants thereof, includes an indirect or direct electrical or mechanical connection.

A device that is “configured to” perform a task or function may be configured (e.g., at least one of programmed or hardwired) at a time of manufacturing by a manufacturer to perform the function or may be configurable (or re-configurable) by a user after manufacturing to perform the function or other additional or alternative functions. The configuring may be through at least one firmware or software programming of the device, through a construction or layout of hardware components and interconnections of the device, or a combination thereof.

Although not all separately labeled in the FIGS. 1-2, components or elements of systems and circuits illustrated therein have one or more conductors or terminus that allow signals into or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on particular circuitry or system topology, there may be more or fewer terminals and nodes. However, in some instances, “terminal,” “node,” “interconnect,” “pad,” and “pin” may be used interchangeably.

The term “or” as used, for example, in a form such as A, B, or C refers to any combination or subset of A, B, C such as (1) A alone, (2) B alone, (3) C alone, (4) A with B, (5) A with C, (6) B with C, or (7) A with B and with C.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Example methods, apparatus, systems, and articles of manufacture corresponding to a sensor system operating with multiple clock frequencies are described herein. Further examples and combinations thereof include the following: Example 1 includes an apparatus comprising a media access control layer configurable to provide first data in a first format and receive second data in the first format, a first buffer configurable to store the first data from the media access control layer, encapsulation controller configurable to convert the first data in the first format to a second format, a transmitter having an input and an output, the input of the transmitter coupled to an output of the encapsulation controller, a second buffer configurable to provide stored data in the first format to the media access control layer, the stored data including the second data, and a controller configurable to, after an amount of data in the first buffer is above a threshold, store a pause frame in the second buffer.
Example 2 includes the apparatus of example 1, wherein the second buffer provides the pause frame to the media access control layer, and the media access control layer stops sending additional data to the first buffer based on the pause frame.
Example 3 includes the apparatus of example 1, wherein the first format corresponds to an Ethernet protocol and the second format corresponds to a serial protocol.
Example 4 includes the apparatus of example 1, wherein the first buffer receives the first data in the first format from the media access control layer.
Example 5 includes the apparatus of example 1, wherein the output of the transmitter is coupled to a flat panel display link.
Example 6 includes the apparatus of example 1, further including a receiver having an input and an output, the input of the receiver coupled to a link, the output of the receiver coupled to the second buffer, wherein the second buffer is configurable to receive the second data, the second data received by the receiver in the first format and converted to the second format, and store the second data.
Example 7 includes the apparatus of example 1, wherein the controller is configurable to store the pause frame in the second buffer to adapt a first baud rate corresponding to the first format to a second baud rate corresponding to the second format.
Example 8 includes the apparatus of example 1, wherein the controller is configurable to store the pause frame in the second buffer to cause the media access control layer to stop sending additional data to the first buffer for an amount of time.
Example 9 includes an apparatus comprising a first buffer configurable to store first data in a first format, encapsulation controller configurable to convert the first data in the first format to a second format, a transmitter having an input and an output, the input of the transmitter coupled to an output of the encapsulation controller, the output of the transmitter coupled to a first endpoint, a second buffer configurable to provide stored second data in the first format to a second endpoint, and a controller configurable to cause the first endpoint to stop sending additional data to the second buffer based on an amount of data in the second buffer being above a threshold.
Example 10 includes the apparatus of example 9, wherein the first format corresponds to an Ethernet protocol and the second format corresponds to a serial protocol.
Example 11 includes the apparatus of example 9, wherein the first buffer receives the first data in the first format from a media access control layer of the second endpoint.
Example 12 includes the apparatus of example 9, wherein the output of the transmitter is coupled to a flat panel display link.
Example 13 includes the apparatus of example 9, further including a receiver having an input and an output, the input of the receiver coupled to a link, the output of the receiver coupled to the second buffer, wherein the second buffer is configurable to receive the second data, the second data received by the receiver in the first format and converted to the second format, and store the second data.
Example 14 includes the apparatus of example 9, wherein the controller is configurable to cause the first endpoint to stop sending additional data to the second buffer.
Example 15 includes the apparatus of example 9, wherein the controller is configurable to cause the first endpoint to stop sending additional data to the second buffer by storing a pause frame in the first buffer, further including receiver circuitry to transmit the pause frame to the first endpoint.
Example 16 includes the apparatus of example 9, wherein the first endpoint is a processor and the second endpoint is a sensor.
Example 17 includes a system comprising sensor circuitry including an input and an output, the sensor circuitry configurable to monitor an amount of data stored in a second buffer, the second buffer storing received data from a processor endpoint, and after the amount of data stored in the second buffer is above a threshold, store a pause frame into a first buffer, the first buffer storing data to be transmitted to the processor endpoint, and the processor endpoint including an input and an output, the input of the processor endpoint coupled to the output of the sensor circuitry and the output of the processor endpoint coupled to the input of the sensor circuitry, the processor endpoint configurable to transmit the data to the sensor circuitry, and after receiving the pause frame from the sensor circuitry, pause transmission of the data to the sensor circuitry for a threshold amount of time.
Example 18 includes the system of example 17, wherein the data is first data, the amount of data is a first amount of first data, and the threshold is a first threshold, the sensor circuitry configurable to monitor a second amount of second data stored in the first buffer, and after the amount of data stored in the first buffer is above a second threshold, store the pause frame in the second buffer.
Example 19 includes the system of example 17, wherein the processor endpoint is configurable to transmit the data in a first format, the sensor circuitry to decapsulate the data into a second format prior to storing in the second buffer.
Example 20 includes the system of example 19, wherein the first format corresponds to a serial format and the second format corresponds to an Ethernet format.
Example 21 includes a vehicle comprising a media access control layer configurable to provide first data in a first format and receive second data in the first format, a first buffer configurable to store the first data from the media access control layer, encapsulation controller configurable to convert the first data in the first format to a second format, a transmitter having an input and an output, the input of the transmitter coupled to an output of the encapsulation controller, a second buffer configurable to provide stored data in the first format to the media access control layer, the stored data including the second data, and a controller configurable to, after an amount of data in the first buffer is above a threshold, store a pause frame in the second buffer.
Example 22 includes the vehicle of example 21, further including a receiver having an input and an output, the input of the receiver coupled to a link, the output of the receiver coupled to the second buffer, wherein the second buffer is configurable to receive the second data, the second data received by the receiver in the first format and converted to the second format, and store the second data.
Example 23 includes the vehicle of example 21, wherein the controller is configurable to store the pause frame in the second buffer to adapt a first baud rate corresponding to the first format to a second baud rate corresponding to the second format.
Example 24 includes the vehicle of example 21, wherein the controller is configurable to store the pause frame in the second buffer to cause the media access control layer to stop sending additional data to the first buffer for an amount of time.

Modifications are possible in the described examples, and other examples are possible, within the scope of the claims.

What is claimed is:

1. An apparatus comprising:
a media access control layer configurable to provide first data in a first format and receive second data in the first format;
a first buffer configurable to store the first data from the media access control layer;
encapsulation controller configurable to convert the first data in the first format to a second format;
a transmitter having an input and an output, the input of the transmitter coupled to an output of the encapsulation controller;
a second buffer configurable to provide stored data in the first format to the media access control layer, the stored data including the second data; and
a controller configurable to, after an amount of data in the first buffer is above a threshold, store a pause frame in the second buffer.

2. The apparatus of claim 1, wherein:
the second buffer provides the pause frame to the media access control layer; and
the media access control layer stops sending additional data to the first buffer based on the pause frame.

3. The apparatus of claim 1, wherein the first format corresponds to an Ethernet protocol and the second format corresponds to a serial protocol.

4. The apparatus of claim 1, wherein the first buffer receives the first data in the first format from the media access control layer.

5. The apparatus of claim 1, wherein the output of the transmitter is coupled to a flat panel display link.

6. The apparatus of claim 1, further including a receiver having an input and an output, the input of the receiver coupled to a link, the output of the receiver coupled to the second buffer, wherein the second buffer is configurable to:
receive the second data, the second data received by the receiver in the first format and converted to the second format; and
store the second data.

7. The apparatus of claim 1, wherein the controller is configurable to store the pause frame in the second buffer to adapt a first baud rate corresponding to the first format to a second baud rate corresponding to the second format.

8. The apparatus of claim 1, wherein the controller is configurable to store the pause frame in the second buffer to cause the media access control layer to stop sending additional data to the first buffer for an amount of time.

9. An apparatus comprising:
a first buffer configurable to store first data in a first format;
encapsulation controller configurable to convert the first data in the first format to a second format;
a transmitter having an input and an output, the input of the transmitter coupled to an output of the encapsulation controller, the output of the transmitter coupled to a first endpoint;
a second buffer configurable to provide stored second data in the first format to a second endpoint; and
a controller configurable to cause the first endpoint to stop sending additional data to the second buffer based on an amount of data in the second buffer being above a threshold.

10. The apparatus of claim 9, wherein the first format corresponds to an Ethernet protocol and the second format corresponds to a serial protocol.

11. The apparatus of claim 9, wherein the first buffer receives the first data in the first format from a media access control layer of the second endpoint.

12. The apparatus of claim 9, wherein the output of the transmitter is coupled to a flat panel display link.

13. The apparatus of claim 9, further including a receiver having an input and an output, the input of the receiver coupled to a link, the output of the receiver coupled to the second buffer, wherein the second buffer is configurable to:
receive the second data, the second data received by the receiver in the first format and converted to the second format; and
store the second data.

14. The apparatus of claim 9, wherein the controller is configurable to cause the first endpoint to stop sending additional data to the second buffer.

15. The apparatus of claim 9, wherein the controller is configurable to cause the first endpoint to stop sending additional data to the second buffer by storing a pause frame in the first buffer, further including receiver circuitry to transmit the pause frame to the first endpoint.

16. The apparatus of claim 9, wherein the first endpoint is a processor and the second endpoint is a sensor.

17. A system comprising:
sensor circuitry including an input and an output, the sensor circuitry configurable to:
monitor an amount of data stored in a second buffer, the second buffer storing received data from a processor endpoint; and
after the amount of data stored in the second buffer is above a threshold, store a pause frame into a first buffer, the first buffer storing data to be transmitted to the processor endpoint; and
the processor endpoint including an input and an output, the input of the processor endpoint coupled to the output of the sensor circuitry and the output of the processor endpoint coupled to the input of the sensor circuitry, the processor endpoint configurable to:
transmit the data to the sensor circuitry; and
after receiving the pause frame from the sensor circuitry, pause transmission of the data to the sensor circuitry for a threshold amount of time.

18. The system of claim 17, wherein the data is first data, the amount of data is a first amount of first data, and the threshold is a first threshold, the sensor circuitry configurable to:
monitor a second amount of second data stored in the first buffer; and
after the amount of data stored in the first buffer is above a second threshold, store the pause frame in the second buffer.

19. The system of claim 17, wherein the processor endpoint is configurable to transmit the data in a first format, the sensor circuitry to decapsulate the data into a second format prior to storing in the second buffer.

20. The system of claim 19, wherein the first format corresponds to a serial format and the second format corresponds to an Ethernet format.

21. A vehicle comprising:
a media access control layer configurable to provide first data in a first format and receive second data in the first format;
a first buffer configurable to store the first data from the media access control layer; encapsulation controller configurable to convert the first data in the first format to a second format;
a transmitter having an input and an output, the input of the transmitter coupled to an output of the encapsulation controller;
a second buffer configurable to provide stored data in the first format to the media access control layer, the stored data including the second data; and
a controller configurable to, after an amount of data in the first buffer is above a threshold, store a pause frame in the second buffer.

22. The vehicle of claim 21, further including a receiver having an input and an output, the input of the receiver coupled to a link, the output of the receiver coupled to the second buffer, wherein the second buffer is configurable to:
receive the second data, the second data received by the receiver in the first format and converted to the second format; and
store the second data.

23. The vehicle of claim 21, wherein the controller is configurable to store the pause frame in the second buffer to adapt a first baud rate corresponding to the first format to a second baud rate corresponding to the second format.

24. The vehicle of claim 21, wherein the controller is configurable to store the pause frame in the second buffer to cause the media access control layer to stop sending additional data to the first buffer for an amount of time.
